(19) United States
(12) Patent Application Publication
(10) Pub. No.: US 2017/0277282 A1
(43) Pub. Date: Sep. 28, 2017

(54) INPUT DEVICE FOR TRANSMITTING USER INPUT

(71) Applicant: WIDEVANTAGE INC., Seoul (KR)

(72) Inventor: Jae Yong Go, Seoul (KR)

(21) Appl. No.: 15/618,546

(22) Filed: Jun. 9, 2017

Related U.S. Application Data
(63) Continuation-in-part of application No. 14/427,836, filed on Mar. 12, 2015.

(30) Foreign Application Priority Data
Sep. 14, 2012 (KR) 10-2012-0102474

(51) Int. Cl. G06F 3/0346; G06F 3/038; G06F 3/044; G06F 3/0338

(52) U.S. Cl. CPC G06F 3/0346; G06F 3/0338; G06F 3/0383; G06F 3/044

(57) ABSTRACT

A input device for transmitting a user input using a magnetic field generator is disclosed. The input device for transmitting a user input to an electrical device may include a base portion fixed to a predetermined location of the electrical device, and a grip portion connected to the base portion through an elastic member and having a regression characteristic to return to a direction of the base portion in response to the grip portion being separated from the base portion by a preset distance or greater. A displacement or a rotation of the grip portion may be determined based on prior physical information of the input device and a value obtained by sensing a movement of the grip portion by a sensor in the electrical device.

### CROSS-REFERENCE TO RELATED APPLICATIONS

This application is a continuation-in-part (CIP) of copending application U.S. Ser. No. 14/427,836, filed on Mar. 12, 2015, which is a National Phase application filed under 35 USC 371 of PCT International Application No. PCT/KR2013/008347 with an International Filing Date of Sep. 16, 2013, which claims under 35 U.S.C. §119(a) the benefit of Korean Application No. 10-2012-0102474, filed Sep. 14, 2012, the entire contents of which are incorporated herein by reference.

### TECHNICAL FIELD

The present disclosure relates to an input device for transmitting a user input.

### DESCRIPTION OF THE RELATED ART

Since the beginning of the PC era, a mouse has been used as a 2D or 2-DOF (degree of freedom) device for inputting movements in both x-axis and y-axis directions. Then, U.S. Pat. No. 7,317,448 to Logitech Inc. in USA disclosed the use of two optical sensors to increase the resolution of a mouse, and the implementation of a 3-DOF configuration capable of recognizing the rotating angle r of the mouse. Later, a laptop computer with a track pad was introduced and used widely such that the flat screen of the computer could be turned off when a finger is tapped on against the screen. Along with the emergence of tablet PCs and smart phones, such track pads were evolutionally advanced to a touchscreen input device where the user directly presses or pans an object that appears to be transparent on a display screen operating in an (electrostatic) capacitive or static pressure mode. The touchscreen receives a user input made by pressing a fingertip against the screen or using a pen or a stylus. In particular, Wacom Co., Ltd. of Japan produced a stylus by employing its patented technology (U.S. Pat. No. 6,556,190) based on the electromagnetic and magnetic resonance power delivery called EMR (electromagnetic resonance), which has a wide range of applications in POS input devices and some smart phones and tablets. This Wacom stylus features advanced functions, i.e. it is capable of distinguishing the tip of a stylus from a finger or even a greater portion of the hand that might be on the input pad for better processing, and of measuring an applied pressure in order to adjust the thickness of a pen stroke. In addition to these Wacom pens, other touch pens that may be produced at lower costs have been used as a major input device for smart phones and tablets. A touch pen is an accessory for general input purposes, such as, drawing by touching a capacitive multi-touchscreen with a nib made of conductive materials or simply by applying a mechanical pressure to a static pressure screen, or selecting a menu, dragging and so on without using a finger. Although the touch pen is also a 2-DOF input device for inputting coordinates on a flat screen, it is not capable of distinguishing the touch of a touch pen from the touch of a palm against the touchscreen such that it cannot only allow the user to write on the touchscreen with a greater portion of the user's hand is still in touch with the screen, but it also cannot measure an applied pressure, failing to adjust the stroke of the pen.

In particular, when an object to be handled is a 3D object, it is hard to derive an intuitive and easy operation from the 2D operation using, such as, a touchscreen, a mouse or a track pad for example. First of all, an object in three dimensions has 6-DOF, i.e. dragging (zoom, pan) along three independent axes and rotation (roll, pitch, yaw) about three independent axes. Even with the multi-touch method, two fingers can only lead to 4-DOF, and an additional finger besides the thumb and the index finger does not necessarily facilitate an intuitive input of a high DOF as it is not likely to move independently.

One way of resolving the aforementioned issue is a 3D mouse. Among others, 3d Connexion has succeeded to a great extent and introduced a knob type mouse in U.S. Pat. No. 7,215,323, making it possible for the user to hold the mouse in one hand and drag and turn it in 3D directions, thereby achieving 6-DOF. Unfortunately, this mouse has a number of embedded sensors, a complicated circuit to which power needs to be supplied, and a mechanically complicated structure, which together cause higher implementation costs.

Moreover, there has been an attempt to solve the issue of input in 3D with the help of software and diverse accelerometers installed in any existing smart phones such as iPhones, or tablets. For instance, Duke University in USA ran a project called ‘Phone Point Pen,’ in which the gyrometer and the accelerometer of a smart phone track and recognize a letter written in the air by a user using the smart phone, and then change them into pen strokes on the software. Also, InvenSense Inc. in USA claimed in its report “Motion Processing” that a sensor can measure a change in the speed as well as the angle and displacement of the 6-DOF through the “sensor fusion algorithm” which is responsible for removing noises for example and performing proper differential and integral operations, with reference to all inputs from the gyrometer, the accelerometer and the e-Compass. But it is also the well-accepted opinion that obtaining an absolute displacement via integrating the acceleration twice is practically impossible especially in the surroundings where a lot of noises are generated by slight shaking of the hand, inclination due to a shaft of the centroid of an object, the motion of the user's body itself, rotation and so on. Except for special situations where the acceleration associated with the motion is sufficiently larger than noises, such as, writing letters in big and fast motion in the air, it is virtually impossible in the majority of cases to obtain a substantially accurate displacement value by the noise. One cannot possibly apply this technology to the situation especially where a mouse is manipulated or operated within a short distance range of several centimeters.

Those simple input devices available up to date, including a mouse, a trackball, a static pressure-capacitive stylus or the like, are advantageous in that they are inexpensive and have a small volume such that they can easily be applied to portable computers such as smart phones or tablets. However, they are also disadvantageous in that an input operation is troublesome and not intuitive, and for a single person to possess all of these different input devices, the sensors, circuits, communication interfaces, power supplies etc. installed in the respective devices together make the devices rather expensive, heavy and bulky.

Meanwhile, there is a more complicated input device, a multi-touchscreen, which has already been provided to portable computers, allowing the user to press it with a finger or a capacitive stylus and to make various inputs intuitively on the flat surface, e.g., taking notes, selecting, zooming, panning and so on. However, this stylus also cannot distinguish the location of the nib from a palm, thereby forcing the user to write in the air while his or her hand is being lifted up over the screen. Further, if a virtual 3D object needs to be operated by the software, it is very difficult to perform an intuitive operation.

Other motion game devices such as Will or Kinect include, in addition to the accessory, diverse sensors, a micro controller, a power supply, and the like such that their hardware construction cost is too high to be applied to a portable computer, and more fundamentally those devices use a camera as a sensor, meaning that the line of sight from the sensor to the user's body or the target item has to be secured, which together make them inappropriate for use in making an input to a portable apparatus where the user uses several fingers for operation in the immediate vicinity from the display screen.

Furthermore, U.S. Pat. No. 8,376,854 discloses the use of a compass sensor to recognize a gesture based on a movement of the magnetic element. However, this compass sensor can only sense a movement of the magnetic element, and cannot verify the detailed information such as the displacement or the rotation of the magnetic element.

A joystick, which was widely used in games or radio control (RC) toys, is a device that is attached onto a base plane to bend or push a grip portion held by a hand or a finger of a user in a direction on the base plane, and to control an input, for example, a 2D input, based on a bent angle or a pushed location. That is, such a general-type joystick may control only a 2D or 2-DOF input with respect to x and y axes that determine the base plane.

### SUMMARY

The present disclosure makes use of a magnetometer already available in a mobile communication terminal or a portable computer for making a motion input, such that the user can operate a movable object (accessory) having a magnet only without any of a sensor, a circuit and a power supply, and the mobile communication terminal or the portable computer can recognize or determine different intuitive motions and then change the status of an object on the software in order to facilitate the operations of geospatial applications such as Graphic editor, motion games, Street View or Google Earth. In particular, the use of a magnetic field makes it possible to resolve the problem of securing the line of sight, a possible issue in mobile communication terminals or portable computers that are operated mainly by using fingers in a limited space.

According to the present disclosure, in order to figure out motions of an object (accessory) in 3D space having 6-DOF with a magnetometer of a limited dimension installed in a mobile communication terminal or a portable computer, the motions of the object (accessory) are measured at different time points using physical constraints and presumptions that are applied while the object (accessory) is moving, or imposes physical limits on the motions of the object (accessory) and the corresponding motion values are calculated by a control portion 280 (software) of the mobile communication terminal or the portable computer.

Also, according to the present disclosure, in order to make additional use of an acceleration sensor, e.g., an accelerometer or gyroscope available in most existing portable computers, for the recognition of a motion, an object (accessory) having a magnet is fixed, and a user holds a mobile communication terminal or a portable computer in hand and operates it, allowing the mobile communication terminal or the portable computer to determine a relative location from the object and proceed its processing.

According to an aspect, there is provided an input device for transmitting a user input to an electrical device, the input device including a base portion fixed to a predetermined location of the electrical device, and a grip portion connected to the base portion through an elastic member and having a regression characteristic to return to a direction of the base portion in response to the grip portion being separated from the base portion by a preset distance or greater. A displacement and a rotation of the grip portion may be determined based on prior physical information of the input device and a value obtained by sensing a movement of the grip portion by a sensor in the electrical device.

The input device may further include a magnetic field generator connected between the base portion and the grip portion through the elastic member. The sensor in the electrical device may be a magnetometer, and the value obtained by sensing the movement of the grip portion by the sensor may include a magnetic field vector detected by the magnetometer from the magnetic field generator.

In response to the grip portion being separated farther apart from the base portion based on the user input, the magnetic field generator may have a shorter moving distance compared to a moving distance of the grip portion.

The grip portion may include a magnetic field generator and the sensor in the electrical device may be a magnetometer, and the value obtained by sensing the movement of the grip portion by the sensor may include a magnetic field vector detected by the magnetometer from the magnetic field generator.

In response to the sensor in the electrical device being an image sensor, the value obtained by sensing the movement of the grip portion by the sensor may include a movement image obtained by capturing an image of the movement of the grip portion. In response to the sensor in the electrical device being a depth sensor, the value obtained by sensing the movement of the grip portion by the sensor may include depth information associated with the movement of the grip portion.

The user input may interact with a virtual object displayed on a display in the electrical device. The virtual object may be displayed on a surrounding image captured by an image sensor in the electrical device, or projected to a transparent plate inclined with respect to the display at a preset angle.

According to another aspect, there is provided an input device for transmitting a user input to an electrical device, the input device including a base portion fixed to a predetermined location of the electrical device, and a grip portion having a center-based regression characteristic to return to a predetermined location of the base portion, and configured to move while being in contact with the base portion or move to be located in a 3D space separated from the base portion. A displacement or a rotation of the grip portion may be determined based on prior physical information of the input device and a value obtained through sensing associated with the grip portion by a sensor in the electrical device.

The prior physical information of the input device may include information associated with the location of the electrical device to which the base portion is fixed.

The prior physical information of the input device may include restriction information associated with a restriction on a movement of the grip portion.

The restriction information associated with the restriction on the movement of the grip portion may include information associated with a movable range in which the grip portion is movable while being in contact with the base portion by the user input and information associated with an available location range in which the grip portion is separated from the base portion and located in the 3D space.

The restriction information associated with the restriction on the movement of the grip portion may include information associated with an original location of the grip portion at which the grip portion is located in the absence of a user input about the grip portion.

A user input allowing the grip portion to move while being in contact with the base portion may be recognized based on a distance between the base portion and the grip portion.

The user input allowing the grip portion to move while being in contact with the base portion may be recognized further based on at least one of a difference between an arrangement direction of the base portion and an arrangement direction of the grip portion or a distance, to the grip portion, from the original location of the grip portion at which the grip portion is located in the absence of the user input about the grip portion.

The user input allowing the grip portion to move while being in contact with the base portion may be recognized based on a potential difference between two electrodes disposed in the base portion, whether the potential difference is less than or equal to a reference value predetermined by the grip portion that is conductive, or whether a capacitance or a capacitive pressure changes by the grip portion.

A user input allowing the grip portion located in the 3D space separated from the base portion to return to the original location based on the center-based regression characteristic may be recognized based on a change in a magnetic field generated based on a movement of the grip portion returning to the original location, in response to the grip portion including a magnetic field generator and the sensor in the electrical device being a magnetometer.

In response to the sensor in the electrical device being an image sensor, the sensor may recognize a movement of the grip portion based on an image obtained by capturing an image of the grip portion by the sensor. In response to the sensor in the electrical device being a depth sensor, the sensor may recognize a movement of the grip portion based on depth information associated with the grip portion.

A direction in which the grip portion located in the 3D space separated from the base portion returns to the original location may be determined based on a previous location at which the grip portion is located immediately before returning to the original location and on the original location of the grip portion.

In response to the grip portion including a magnetic field generator and the sensor in the electrical device being a magnetometer, the displacement or the rotation of the grip portion may be determined based on an external magnetic field determined based on the original location of the grip portion in the absence of an user input about the grip portion and a magnetic field vector detected by the sensor in response to the grip portion being located at the original location.

The center-based regression characteristic of the grip portion may be based on an elastic member connecting the grip portion and the base portion or an electromagnetic attractive force between the grip portion and the base portion.

In response to the sensor in the electrical device being the magnetometer, an m dimension of a magnetic field vector detected by the magnetometer may be less than n-DOF of the grip portion.

The user input allowing the grip portion to move while being in contact with the base portion and the user input allowing the grip portion to be located in the 3D space separated from the base portion may induce different types of operations in the electrical device.

The user input allowing the grip portion located in the 3D space separated from the base portion to return to the original location based on the center-based regression characteristic may induce a subsequent operation after an operation of the electrical device performed by the user input allowing the grip portion to be located in the 3D space.

The input device may further include an image sensor fixed to the base portion and configured to capture an image of the grip portion. The displacement or the rotation of the grip portion may be determined based further on an image output from the image sensor.

According to still another aspect, there is provided an input device for transmitting a user input to an electrical device, the input device including a base portion, and a grip portion having a center-based regression characteristic to return to a predetermined location of the base portion, and configured to move while being in contact with the base portion or be movable to be located in a 3D space separated from the base portion. A displacement or a rotation of the grip portion may be determined based on prior physical information of the input device and a value obtained by a sensor by sensing a relative movement between the base portion and the grip portion.

In response to the sensor being a magnetometer included in the base portion, the magnetometer may detect a magnetic field vector from a magnetic field generator included in the grip portion. In response to the sensor being a magnetometer included in the grip portion, the magnetometer may detect a magnetic field vector from a magnetic field generator included in the base portion.

According to yet another aspect, there is provided an input device for transmitting a user input to an electrical device, the input device including a grip portion including a magnetic field generator, and an elastic member configured to allow the grip portion to return to a predetermined location of the electrical device. A displacement of the grip portion may be determined based on prior physical information of the input device and a magnetic field vector detected by a magnetometer in the electrical device from the magnetic field generator.

The prior physical information of the input device may include at least one of information associated with an original location of the grip portion at which the grip portion is located in the absence of a user input about the grip portion and on a rotation of the grip portion, or information associated with an external magnetic field determined based on a magnetic field vector detected in response to the grip portion being located at the original location.

The input device may further include a control portion configured to determine the displacement or the rotation of the grip portion based on the prior physical information of the input device and a value obtained by a sensor by sensing a relative movement between the base portion and the grip portion.

The input device may further include a communication portion configured to transmit, to the electrical device, the value obtained by the sensor by sensing the relative movement between the base portion and the grip portion or information derived from the relative movement. The electrical device may determine the displacement or the rotation of the grip portion based on the prior physical information of the input device and the value obtained by the sensor.

According to further another aspect, there is provided an input device for transmitting a user input to an electrical device, the input device including a grip portion including a magnetic field generator and configured to move while being in contact with a touchscreen of the electrical device or be movable to be located in a 3D space separated from the touchscreen, and an elastic member connected to the grip portion and configured to allow the grip portion to return to a predetermined location of the electrical device. A displacement or a rotation of the grip portion may be determined based on prior physical information of the input device, a magnetic field vector generated by a magnetometer in the electrical device from the magnetic field generator, and a touch generated from the touchscreen in response to the grip portion being in contact with the touchscreen.

In response to the touchscreen being a capacitive touchscreen, a surface of the grip portion touching the touchscreen may be conductive.

The present disclosure makes use of a magnetometer, a touchscreen and so on, which are already available in a portable computer for making a motion input to the portable computer, such that various user inputs such as intuitive motions can be made or input to a computer software through an accessory having merely a magnet or touchscreen input touch points, without any of a sensor, a circuit and a power supply, and then the status of an object on the software is changed in order to facilitate the operations of geospatial applications such as Graphic editor, motion games, Street View or Google Earth.

Moreover, through a magnetic field-sensing operation, the present disclosure effectively overcomes the problem of securing the line of sight for sensing in a portable computer that is operated mainly by using fingers in a limited space. Also, the present disclosure makes it possible to calculate necessary motion values for the accessory only with limited inputs from the magnetometer that senses a magnetic field into the form of a 3D vector and to change actions or colors of a content displayed on the screen, such that an operation in response to a user input can be performed.

In addition, the present disclosure involves at least two types of sensors; especially in case of a portable computer, the coordinates of a pressed point on a touchscreen as well as the value of a magnetic field vector sensed in a 3D magnetometer are referred together. As such, low-cost, smaller input accessories as compared with those existing ones can be implemented, which in turn can increase the DOF of an input and enables convenient, intuitive inputs from the user, resulting in improved user convenience.

Furthermore, according to the present disclosure, as the user makes an input by moving a smart phone, a microphone already available in such a portable device can be used for recognition even when those motions of the user to be sensed, e.g., putting the smart phone on the ground and dragging, holding the smart phone in the air and returning it to a convenient location, or trampling may be done away from the portable computer by several tens of centimeters or more.

### BRIEF DESCRIPTION OF THE DRAWINGS

The above and other objects, features and advantages of the present disclosure will become apparent from the following description of a preferred embodiment given in conjunction with the accompanying drawings, in which:

FIG. 1 is a diagram illustrating a user input system including an electrical device and a movable object including a magnet according to an example embodiment.

FIG. 2 is a diagram illustrating a first example of the user input system of FIG. 1.

FIG. 3 is a diagram illustrating a second example of the user input system of FIG. 1.

FIG. 4 is a diagram illustrating a third example of the user input system of FIG. 1.

FIG. 5 is a diagram illustrating a fourth example of the user input system of FIG. 1.

FIG. 6A is a diagram illustrating a fifth example of the user input system of FIG. 1.

FIGS. 6B and 6C are diagrams illustrating modifications of the fifth example of the user input system of FIG. 1.

FIG. 7 is a diagram illustrating a sixth example of the user input system of FIG. 1.

FIG. 8 is a diagram illustrating a seventh example of the user input system of FIG. 1.

FIG. 9 is a diagram illustrating an eighth example of the user input system of FIG. 1.

FIG. 10 is a diagram illustrating an input device according to an example embodiment.

FIG. 11 is a diagram illustrating a joystick mode of an input device according to an example embodiment.

FIG. 12 is a diagram illustrating a slingshot mode of an input device according to an example embodiment.

FIG. 13 is a diagram illustrating an operation of rotating a grip portion of an input device according to an example embodiment.

FIG. 14 is a diagram illustrating another type of an input device according to an example embodiment.

FIGS. 15 through 17 are diagrams illustrating an input device according to another example embodiment.

FIG. 18 is a diagram illustrating a structure to be fixed in response to a grip portion of an input device not being pulled according to another example embodiment.

FIGS. 19 and 20 are diagrams illustrating examples in which a user views a real situation generated in front of the user from an input device according to an example embodiment.

### DETAILED DESCRIPTION

The following will now describe the present disclosure in more detail, with reference to the accompanying drawings and example embodiments.

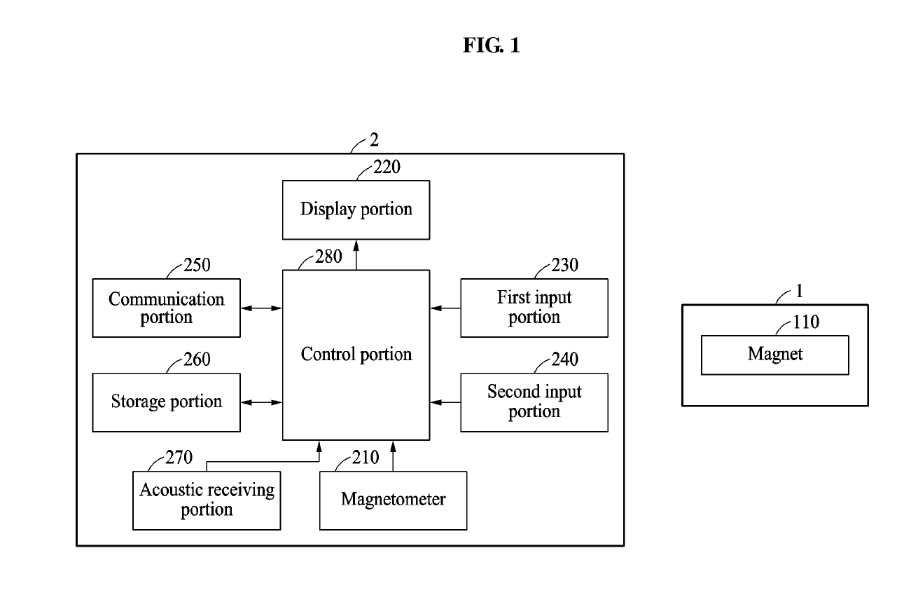

FIG. 1 is a diagram illustrating a user input system including an electrical device and a movable object including a magnet according to an example embodiment.

As shown, the user input system includes a movable object 1 including a magnet 110, and an electrical device 2 for sensing and processing a magnetic field from the magnet 110.

The object 1 includes a body including the magnet 110 inside or outside the body. The object 1 may be embodied in various forms, including, for example, a mouse, a bullet, a touch pen, a ring, a dice, and the like.

The electrical device 2 may be embodied in a mobile communication terminal or a computer, and includes a magnetometer 210 for sensing a magnetic field or a change in the magnetic field, a display portion 220 for displaying screens or information of various programs, a first input portion 230, which is a touchscreen for obtaining a touch input formed on an outer surface of the display portion 220 facing outside, a second input portion 240, for example, a button, embodied in a case (not shown) of the electrical device 2 other than the display portion 220, a communication portion 250 for performing wired or wireless communication with an external communication device (not shown), a storage portion 260 for storing programs or information necessary to execute specific functions of the electrical device 2 and for storing prior physical information or constraints necessary to determine user input information from a motion or a movement of the object 1 or a motion or a movement of the electrical device 2, an acoustic receiving portion 270 for receiving an electric signal or an acoustic signal from outside and then applying acoustic information to a control portion 280, and the control portion 280 for executing specific functions of the electrical device 2, as well as for determining a user input by using the prior physical information or constraints stored in the storage portion 260 and using a sensed value of the magnetic field provided from the magnetometer 210, or for processing other programs or data in response to the thus determined input. Another element of the electrical device 2, i.e. a power supply for supplying power to each element, will not be described here since it is well known to the art to which the present disclosure pertains. Also, the communication portion 250 may be optional.

The magnetometer 210 senses a magnetic field vector of a limited number of dimensions, and applies the sensed value to the control portion 280. The magnetometer 210 is capable of measuring, for example, a three-dimensional (3D) magnetic field vector, and at least one magnetometer 210 is included in the electrical device 2.

The display portion 220, the first and second input portions 230 and 240, the communication portion 250, the storage portion 260, and the acoustic receiving portion 270 described above are a well-known technical construction in the art, and will not thus be described in further detail. The following example embodiments will now describe a process to be performed by the control portion 280 for an accurate determination and processing of a user input, by determining values input through the magnetometer 210, the first input portion 230, and the acoustic receiving portion 270 based on the prior physical information or constraints stored in the storage portion 260.

In one example embodiment, the magnetometer 210 senses a magnetic field from an n-degrees of freedom (DOF) object including a magnet as a magnetic field generator to generate a limited m-dimensional magnetic field vector, wherein n>m. The control portion 280 determines displacement and rotation information of the n-DOF object based on the prior physical information about a motion of the object 1, which is stored in the storage portion 260, and on the limited m-dimensional magnetic field vector. In order to reduce the number of magnetometers 210, the prior physical information about a motion of the object 1 may include, for example, information about (n−m) DOF or more of the object 1.

In addition, in this example embodiment, in order to reduce the number of magnetometers 210, the control portion 280 determines the displacement and rotation information of the object 1 by using the prior physical information about a motion of the object 1 and directly limiting a DOF of a motion of the object 1. For example, the DOF of a motion of the object 1 is limited to 5, and information about such a limitation of the DOF of a motion of the object 1 is stored in advance in the storage portion 260. Later, based on such information about the limitation, the control portion 280 may determine the displacement and rotation information of the object 1. Here, the information about the limitation of the DOF of a motion of the object 1 is also included in the prior physical information of a motion of the object 1.

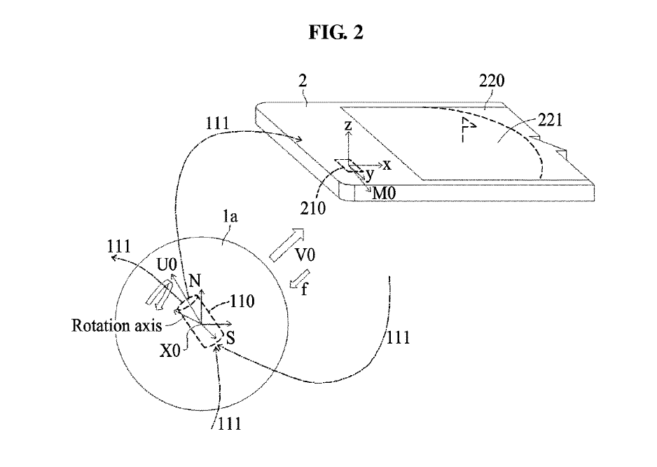

FIG. 2 is a diagram illustrating a first example of the user input system illustrated in FIG. 1 according to an example embodiment.

As shown in FIG. 1, in one example embodiment of the present disclosure, the control portion 280 of the electrical device 2 senses, through the magnetometer 210 of a limited number of dimensions, a change in a magnetic field 111 that is caused by the magnet 110 which is fixed at the center of inside a ball 1a, i.e. a movable object, and rolls together with the ball 1a rolling on the ground, discovers a location of the ball 1a based on the sensed result, and reflects the location to a display screen serving as a virtual object or space such as a putting green displayed on the display portion 220, or to a status of a contents 221. In addition, the control portion 280 employs a user input that is determined based on the change in the magnetic field from the magnetometer 210 through a user input in, for example, a program, game, or an application (app) in process, so as to change a status of the program, game, or app, or to perform a command input, an environment setting, a mode change, a display screen change, and the like.

While the magnetometer 210 receives a 3D magnetic field input, a ball or a rigid body 1a of an accessory performs a 6-DOF motion involving 3D displacements (x, y, z) and 3D rotations (roll, pitch, yaw) in a 3D space. Therefore, the magnetic field input obtained from such a 3D magnetometer 210 is not sufficient to define the location of the accessory including a magnet of the ball, that is, the location of the ball 1a.

The storage portion 260 stores physical constraints that are applied when the accessory moves to determine a location or an angle of an external accessory having a higher DOF from a limited number of values measured by the magnetometer 210, and the control portion 280 performs corresponding calculations based on the physical constraints.

That is, accurate displacement and rotation information of the ball 1a is determined only when a user using the user input system of FIG. 1 rolls the ball 1a in an area separated from the electrical device 2 by at least 30 centimeters (cm), for example. Through the display portion 220, the electrical device 2 informs the user of intuitive rules that are easy to follow in daily life, e.g., an area within a radial distance of 30 cm of the electrical device 2 has to be a flat plane without a curvature and a friction force due to a surface material has to be constant without a sharp change. Then, assuming that the user follows the rules, the control portion 280 may accurately find a motion of the ball 1a. The storage portion 260 stores the rules as the physical constraints or prior information, and the control portion 280 utilizes the stored rules.

When the ball 1a rolls and becomes close to be within a distance of 30 cm or less from the electrical device 2, the magnetic field 111 becomes a large value that is noticeably distinguishable from noise irrelevant to a motion of the ball 1a. Thus, the control portion 280 may determine the information relevant to a motion of the ball 1a by using the magnetic field 111 measured by the magnetometer 210. The ball 1a rolls around a rotation axis.

The control portion 280 determines such a change in the magnetic field 111 as an approach of the ball 1a, and reads a magnetometer value M0, which is a 3D vector, to get ready to reflect the value to the status of the contents 221. Since it is not known where the user rolls the ball 1a, the location of the ball 1a, for example, X0, becomes a variable to be found and is a 2D value as the ball 1a is on a plane. However, although the control portion 280 is informed of a magnetic strength of the magnet 110 sharing the same center with the ball 1a, an angle formed between a magnet dipole and the magnetometer 210 is also given by a 2D vector value U0 of a latitude angle and a longitude angle and the variable M0 to be found may be defined as in the following Equation 1:

M0=F(X0,U0)

That is, the magnetometer value M0 is defined by a function F between the variables X0 and U0, and X0 and U0 may also be found using an inverse function of F. However, the magnetometer value M0 is a 3D value and a DOF of the variables X0 and U0 equals to 4D (2D+2D), and thus it is not possible to obtain the variable X0. Unless other presumptions are used, the location of the ball 1a on the plane may not be found. A traditional method to solve this was placing at least nine magnetometers at scattered locations and employing a high-priced data connection bus for a complete synchronization of the magnetometers, thereby collecting all sensed values at once and obtaining a 3D location and angle through a non-linear optimization.

In this example embodiment, prior physical information and a number of measurement values by time are used to obtain the location of the ball 1a with help of a limited number of magnetometers 210. That is, it is presumed that, with t0 indicating a time at which the magnetic field vector M0 is obtained, a speed of the ball 1a at t0 traveling in the same direction by inertia is V0, i.e. a 2D vector value, of which speed is unknown, and while the traveling direction is unchanged and the traveling speed is determined by a material of a flat plane, the control portion 280 determines that it is accelerated at an equivalent minus velocity by an unknown friction coefficient f. Even under the presumption that the flat plane does not experience gravity-induced bending, it is not significantly different from a real situation. With such prior physical information or presumption, if a magnetic field vector M1 is obtained at a time point t1 after a certain period of time elapses from the time point t0, the magnetic field vector M1 may have a relationship with a location X1 of a center of the ball 1a and the latitude/longitude angle U1 of the magnet 110 as indicated in the following Equation 2:

M1=F(X1,U1)

wherein X1 denotes a value determined by the speed V0 at a location relative to X0, the friction coefficient f, and a time difference between t1 and t0 (t1−t0), among which the time t0 and t1 are confirmed by the control portion 280 using an embedded timer. The angle U1 of the magnet 110 denotes a value determined by a radius r of the ball 1a from the location U0, the speed V0, the friction coefficient f, and the time difference (t1−t0), where the radius r of the ball 1a corresponds to the prior physical information previously stored in the storage portion 260, and the control portion 280 calculates the time difference (t1−t0). Therefore, the magnetic field vector M1 satisfies the following Equation 3:

M1=F′(X0,U0,V0,f)

Again, at a next time point t2, a value of a magnetic field vector M2 equally satisfies a relationship as indicated in the following Equation 4:

M2=F″(X0,U0,V0,f)

Thus, nine equations (=3×3) are obtained from three 3D magnetic field vectors M0, M1, and M2, and seven variables including X0, U0, V0, f and so on still remain unknown. Through the above equations, the control portion 280 may calculate X0, U0, V0 and f, and further determine all of U0, U1, U2 as well as X0, X1, X2. The control portion 280 may use these values of the magnetometer 210 that are sensed at different points of time to verify vector information including, for example, displacement and rotation, of an object having a high DOF compared to the number of dimensions of the magnetometer 210.

Also, under presumptions (prior physical information) that, for example, the ball 1a rolls by skidding on a floor with a certain given spin speed as in bowling or pool, or it is allowed to put an iPad on a tilted surface as in golf putting, the 3D magnetometer 210 may still verify the displacement and rotation information of the ball 1a, with help of additional sampling at staggered time intervals. Although an error may occur as the floor is not perfectly flat or the friction coefficients are not uniform, merely a few simple presumptions stored in the control portion 280 or the storage portion 260 may be sufficient to move a virtual object substantially correspondingly to an intuition of a human being and, in response to the magnet 110 being still within a sensing range after sampling, it is possible to correct the location through continuous sampling and to improve accuracy of parameters such as a friction coefficient that was not known.

Therefore, in order to obtain sufficient information about an object having a higher DOF than the dimensions of a magnetometer using such a magnetometer of limited dimensions, it is necessary to understand that the object in a certain time interval is given with a location and an angle at each point of time by a predefined force therein according to the physical speed and acceleration laws. Then, using, as variables, an unknown location, angle, speed, and angular speed of the object at a certain point of time, and parameters associated with a constant motion independent of the passage of time, sampling the sensed values of the magnetometer obtained at different points of time, and using sensor measurement values that are equal to or higher than the DOF created by those unknown variables as constraints, it is possible to obtain the unknown location, angle, speed, acceleration, motion parameters, and so on. The physical laws for speed and acceleration may be associated with inertia, angular momentum, gravity, friction force, and the like, and the time-independent parameters described above may be a coefficient of friction, a coefficient of elasticity, mass, slope, and the like.

In case of using a dipole magnet having one N pole and one S pole, either point symmetric or line symmetric magnetic fields are formed on every plane perpendicular to the dipole, such that a motion like spinning with respect to the dipole might not be read. When even such information about spinning is needed in the control portion 280, it is suitable to use a number of magnets so as to break the symmetry of a magnet, or use a coded magnet. Particularly, it is preferable to arrange two or three dipole magnets in perpendicular locations to each other. In addition, measurement may be performed, for example, by rotating magnets with respect to an axis perpendicular to the dipole, presuming that each magnet rotates with its own momentum. Moreover, two or three electromagnets being perpendicular to each other may be electrically driven in sequence and then a corresponding magnetic field at a right angle may be measured. Also, for a moving object, a signal may be measured using an RFID as a kind of the electromagnet and supplying power to the electromagnet by a magnetic induction or magnetic resonance method, without a separate power supply.

The control portion 280 may use the displacement and rotation information of the ball 1a to control a virtual putting green as well as various virtual objects, and display the same on the display portion 220. For instance, the control portion 280 may arrange bowling pins or insert a pool table or marble game board outputted in computer graphics. Further, the control portion 280 makes it possible for users at a remote distance from each other to enjoy a game over the network.

With the same principle, the magnetometer 210 measures the trajectory of an object being thrown, and under the presumption that the object is flying without being subject to any other unknown external forces but to the gravity and friction force only, the control portion 280 interprets data from the magnetometer 210 at different points of time to find the location, speed and acceleration of the ball 1a, and reflect the results in a virtual object. For instance, if the electrical device 2 is installed in a small space it only occupies a small area within a limited distance, and an object being thrown will then hit against the wall and fall within a short moment. However, a virtual space in the screen of the display portion 220 has no limit, and a virtual object being thrown may be able to fly far away and hit a target in the virtual space. Here, the space may be set to above the earth, the moon, the Saturn or the like, with different gravitational accelerations being applied respectively. Also, the type of games may include diverse sports, such as basketball, boomerang, throwing a sword, or a shooting game. Additionally, the object throwing ways may be implemented in various manners, e.g., using one hand, using a slingshot gun from a certain distance away, striking with a golf club and the like. The electrical device 2 according to the present disclosure may check simply whether the object has hit the target on the surface of a touchscreen, and it may also measure how further the object being thrown has flown, passing through the touchscreen or an adjacent space and estimate what shape of a curve may be drawn as the object spins, and then reflect these in a corresponding game. In case of a sword-throwing game, for example, beyond the simple measurement of coordinates where the thrown sword and the touchscreen have met each other to see whether or not an object moving on the touchscreen has hit the target, the electrical device may vividly show how the object rotates, passing the touchscreen or adjacent plane, what shape of a trajectory is drawn by the flying object, and whether the object actually hit a 3D target that was set in further inside the screen from different viewpoints of the user, following the trajectory of the sword. Tracing the trajectory of the thrown sword with the magnetometer 210 may also be carried out similarly the example embodiment shown in FIG. 2. That is, merely using the 3D magnetometer 210 may not provide a spatial location of a 6-DOF magnet inside the sword. However, once the sword leaves the hand, it is presumed that the sword is not subject to any of those already known nature laws, namely, the law of inertia and the law of gravity, or any other unknown forces, but it moves by an angular momentum. Then, using those sensed values of the magnetometer 210 at plural time points, the control portion 280 may find an unknown variable as the number of samples increases despite the limited dimensions of each sensed data. Since the sampling operation is done sufficiently fast, a virtual sword flying in the display portion 220 may be reproduced in real time.

All the methods described above make it possible to provide a simulation of an object being thrown, by simply using a magnetometer frequently used in a small-size tablet such as iPad and a smart phone. Considering that the game involves a flying object, it is preferable to have magnetometers distributed on a large screen and in a broad space. The system according to the present disclosure makes it possible to perform broad-band magnetic field sensing by employing universal communications including, for example, WiFi, Bluetooth, Ethernet, USB, and the like, which do not support a plurality of magnetometers and synchronization. For instance, in case of a plurality of electrical devices 2, e.g., smart phones, installed on the wall and doing communications with a central computer or with each other through WiFi, each magnetometer in the respective smart phone may sense an object being thrown, and update the output of every smart phone screen installed.

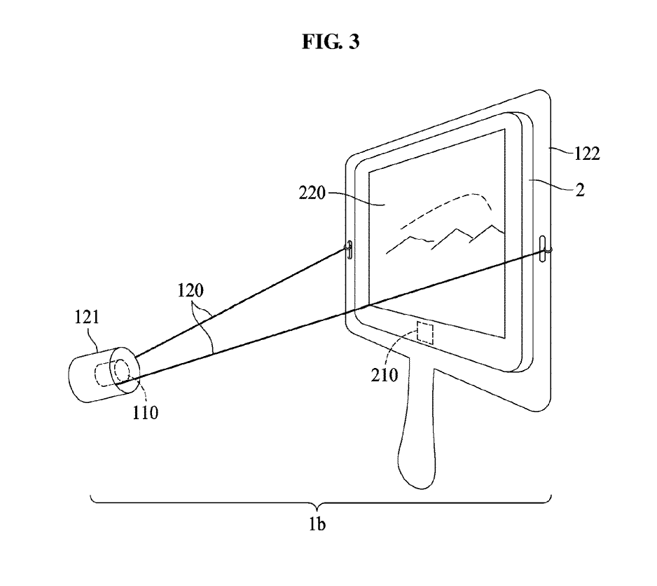

FIG. 3 is a diagram illustrating a second example of the user input system illustrated in FIG. 1. Referring to FIG. 3, a slingshot gun accessory 1b is adapted such that rubber straps 120 of a slingshot gun may be connected to a transparent accessory frame 122 serving to receive the electrical device 2. If a shooting object 121 having the magnet 110 therein is sufficiently light, it may be mainly under the influence of the elastic force of the rubber straps 120, rather than of the gravity. It is impossible for the 3D magnetometer 210 to find a location of the shooting object 121 while a user keeps moving the shooting object 121 in horizontal and vertical directions for aiming, but as soon as the object leaves the user's hand, it is presumed that the magnet 110 inside the shooting object 121 may move according to the physical laws that may be described with a limited number of unknown parameters, such as the direction and magnitude of the elastic force of the elastic straps, and that no other force may not be applied to the shooting object 121. Based on this prior physical information and corresponding sample data obtained from many magnetometers 210, the control portion 280 may trace the trajectory and rotations of the shoot object 121 in space.

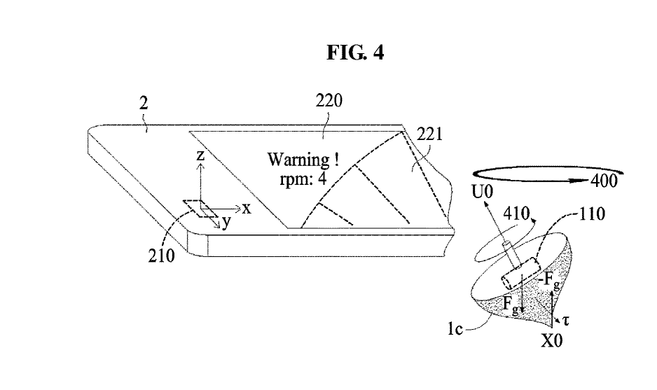

FIG. 4 is a diagram illustrating a third example of the user input system illustrated in FIG. 1. The control portion 280 makes use of the sensed data from the magnetometer 210 to reflect motions of an object by other nature laws, in addition to rolling or throwing near the magnetometer 210, in a virtual object displayed on the display portion 220 and then displays it afresh. By way of example, FIG. 4 shows that the control portion 280 checks the rotation of a top 1c and displays it on the display portion 220. When the top 1c having a magnet 110 therein starts spinning above or next to the electrical device 2, the top 1c spins, as soon as it leaves the hand, by an angular momentum 410, the friction force and the gravity Fg, and it also does precession 400 with torque (τ in FIG. 4) generated by a reaction force −Fg at the center of the top 1c. The control portion 280 uses prior physical information about the precession and rotation motions of the top 1c to find unknown parameters (coefficients) of such motion from the measurement values obtained from the magnetometer 210 at different points of time in a certain time interval, thereby being able to obtain the location X0 or the current angle U0 of the top 1c. Once this locational information is obtained, the control portion 280 may output an animation in real time mode, e.g. showing a fancy top 221 based on the spinning position of the top 1c, or gives a warning alarm about the precession, or have a top-spinning game with a remote user. Likewise, it may also output various accessories, including a carousel frequently used in a roulette or board game, for example.

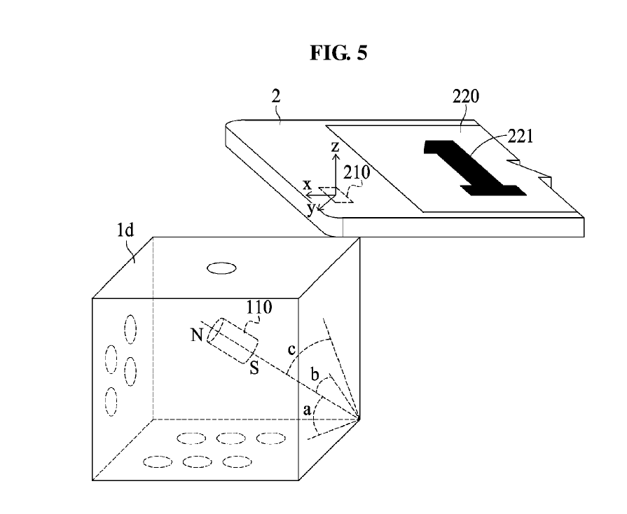

FIG. 5 is a diagram illustrating a fourth example of the user input system illustrated in FIG. 1. Here, a dice 1d is shown as another example. The magnet 110 is inserted into the dice 1d in a manner that the dipole of the dice 1d forms an angle a and −a with the sides 1 and 6, an angle b and −b with the sides 2 and 5, and an angle c and −c with the sides 3 and 4, respectively. Here, c is determined by a and b, and a, b, and c are preferably different as far as possible from each other. As the dipole N-S of the magnet 110 (0°≦a, b, c≦90°) forms one angle out of six angles a, b, c, −a, −b, and −c from the plane according to the number appearing on top of the dice 1d, it is possible to distinguish which number side is on top. In the electrical device 2, the storage portion 260 stores information about the six angles a, b, c, −a, −b, and −c, and information about the size or volume of the dice 1d. The electrical device 2 uses the sensed values of the magnetometer 210 to determine an angle, and then it may decide which number out of 1 to 6 appears on top of the dice 1d. The user throws the dice 1d, the dice 1d lands on the floor, and the user brings the dice 1d near the electrical device 2 towards the magnetometer 210. While the dice 1d is dragging in a relatively linear direction on the flat floor (i.e. this corresponds to prior physical information), the control portion 280 obtains a magnetic field value at each sampling time measured by the magnetometer 210. Since an angle formed between the floor and the magnet 110 depending on which appears on top of the dice 1d, the pattern of magnetic field values at each sampling time also varies. Therefore, the control portion 280 may decide which number appears on top of the dice 1d, based on a change in the magnetic field values at different points of time. In addition, the control portion 280 may estimate which appears on top of the dice 1d, based on the physical relations, such as, the center of gravity, the edges or vertices of the dice 1d or the like.

Also, the control portion 280 may display the number on top of the dice 1d on the display portion 220, or move a horse or show optional strategies according to the number appeared on top of the dice and wait for the selection from the user, and makes it possible for all users distant from each other to enjoy the game over the network.

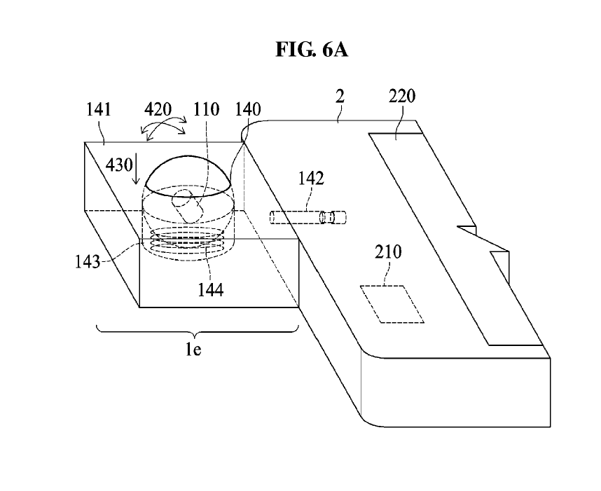

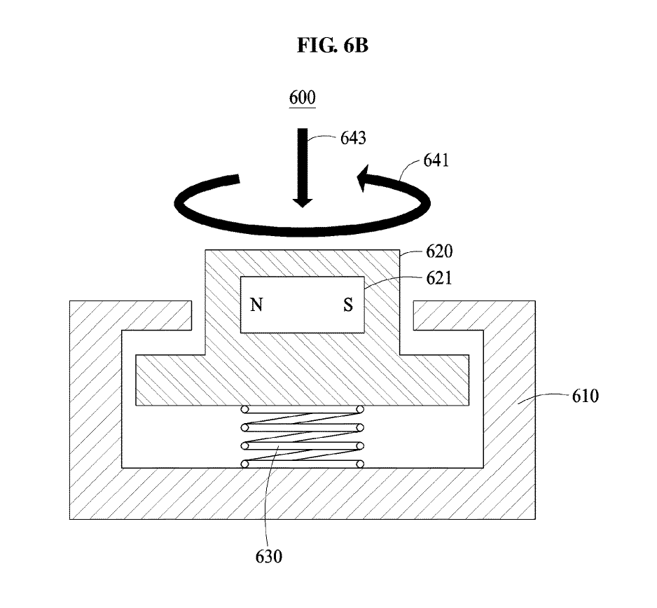

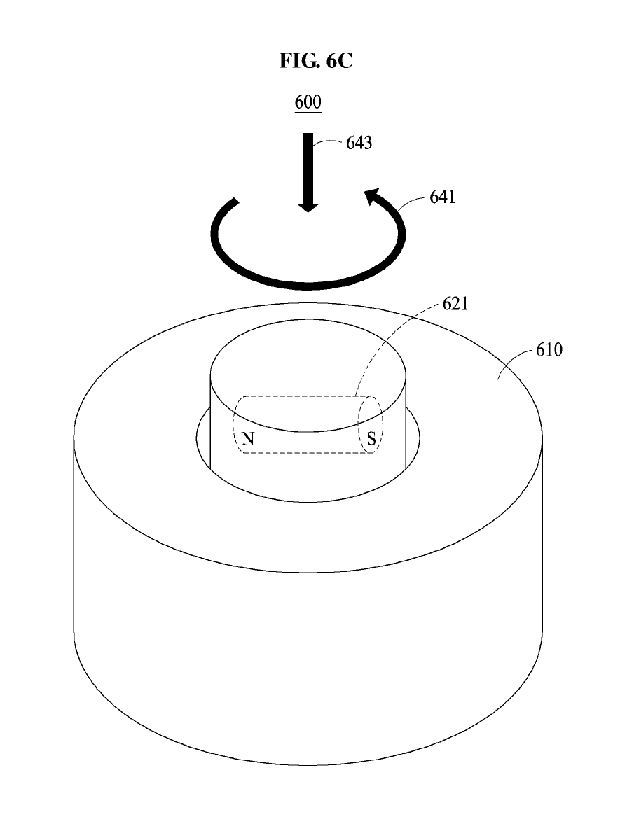

FIG. 6A is a diagram illustrating a fifth example of the user input system illustrated in FIG. 1. As yet another embodiment of the present disclosure, it presents a trackball 1e device which is composed of a magnet and a simple structure and is capable of providing pointing information to the electrical device 2. Since the trackball 1e rotates by user's fingers, it does not seem that the trackball moves by a physical force described as a simple known parameter during a certain time interval. In this case, in order to figure out a user input by using the limited, dimensional magnetometer 210, the electrical device 2 stores, as prior physical information, that there is a physically set limit to the DOF of a motion of a magnet 110 or there is a limit to the user input methods, so as to reduce the DOF of a motion of the magnet 110 and measure a corresponding magnetic field. That is, in case of the trackball 1e, the magnet 110 is embedded inside a rotary ball 140, and this magnet 110 measures a 3D magnetic field vector that influences the magnetometer 210. The portion indicated by a thick solid line in the ball 140 is exposed to outside, which the user may touch with a finger and roll it. The dotted line portion is inserted into an engraved portion inside a frame 141. The engraved portion inside the frame 141 gets narrower upwards from the inner bottom, ensuring that the ball 140 does not pop out. While the ball 140 inside the frame 141 rotates and turns within the engraved portion, when the user inputs something the frame 141 that holds this ball 140 is fixed at a certain interval with the electrical device 2 or at a particular position with a mechanical treatment to prevent any relative movement, or the electrical device 2 informs the user through the display portion 220 that the frame should be put at a designated place and immobilized. One way to fix the frame 141 is making the frame sufficiently heavy and then placing it on the electrical device 2 or attaching it to the side of the electrical device 2 or attaching to the electrical device 2 using tongs or a suction cup. In particular, a plug type frame 141 simply designed to be plugged in and fixed without having any electric contact point may be plugged in and fixed to a headset jack or USB or connector of the electrical device 2 through a tool 142 firmly attached thereto, or it may be bent into a C shape together with the plug such that the trackball 1e may be fixed and immobilized upwards to the electrical device 2. In addition, there are many other ways for fixing the electrical device 2 case with the frame, such as, integrating the two into one body, or integrating the frame and a plug instrument of a charging cable into one body. As such, the frame 141 of the trackball 1e is fixed to the electrical device 2, and the ball 140 is housed in the engraved portion formed in the frame 141 holding the ball 140. As far as the ball 140 is allowed to rotate, the displacement (x, y, z) of the 6-DOF magnet 110 therein is set and the DOF is limited. If the trackball 1e is sufficiently near the magnetometer 210, based on the sensed values of a magnetic force provided to the control portion 280 from the 3D magnetometer 210 and based on the presumption (i.e. prior physical information) that the ball 1e is inserted into the engraved portion of the frame 141 within a certain distance from the electrical device 2, it is possible to calculate a necessary ball rotation vector (roll, pitch), and using this calculated ball rotation vector, it is possible to change and display a virtual object or motor in the display portion 220.

Furthermore, the control portion 280 may recognize a click motion of the ball 140 in a height direction 430. This click in the height direction constructs the lower end portion inside the engraved portion where the ball 140 is housed into a cylindrical shape, and an elastic member such as a spring 144 is provided into the engraved portion under the ball 140. In particular, as the trackball 1e described above may be installed outside the electrical device 2, not above the touchscreen, the user does not need to cover that small display portion 220 screen with one hand, but enjoys the benefit of using a broad area of the display portion 220 screen, which in turn increases the user convenience.

Similar to the trackball, a point stick (or trackpoint) of IBM, which had been broadly used as a pointing device for those traditional laptop computers, may also be incorporated as an ultra-small accessory for use in a portable computer. It is also possible to implement a hand-operated joystick, which has one press button and designed for 2D manipulations (roll, pitch), simply into a 3-DOF device with a magnet and a magnetometer. It would be obvious to a person skilled in the art that the buttons on the trackball, point stick and joystick described above may be implemented with analog buttons that distinguish a pressing depth, besides distinguishing between being pressed and being lifted.

FIGS. 6B and 6C are diagrams illustrating modifications of the fifth example of the user input system illustrated in FIG. 1.

FIG. 6B is a front view of an input device 600 according to an example embodiment.

In FIG. 6B, the ball 140 of FIG. 6A is replaced by a dial-type grip portion 620. The grip portion 620 is rotated in a horizontal direction 641 or clicked in a vertical direction 643. That is, the grip portion 620 may have a 2D DOF in the horizontal direction 641 and the vertical direction 643.

The rotation of the grip portion 620 in the horizontal direction 641 is detected through a magnetic field generated from a magnetic field generator 621 included in the grip portion 620. For example, the rotation of the grip portion 620 in the horizontal direction 641 is detected based on a magnetic direction of the magnetic field generator 621.

In addition, in response to the grip portion 620 being clicked in the vertical direction 643, the grip portion 620 returns to an original location through an elastic member 630 in the input device 600. The elastic member 630 may be, for example, a spring.

A base portion 610 is a structure corresponding to the frame 141 of FIG. 6A, and used to limit a motion or a movement of the grip portion 620 to a preset range. For example, the base portion 610 is fixed to a predetermined location of an electrical device.

FIG. 6C is a perspective view of the input device 600 according to an example embodiment.

A user may grab the grip portion 620 protruding out of the base portion 610, and then rotate the grip portion 620 in the horizontal direction 641 or click the grip portion 620 in the vertical direction 643 while grabbing the grip portion 620.

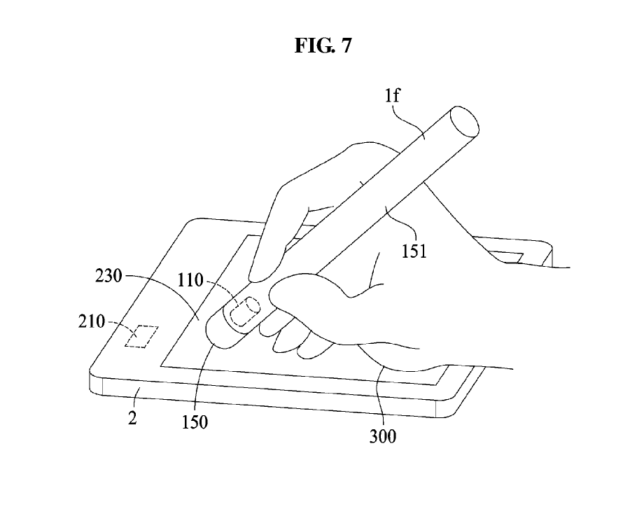

FIG. 7 is a diagram illustrating a sixth example of the user input system illustrated in FIG. 1.

The DOF of an accessory such as the trackball which is manually operated by a person, not by the law of motions, needs to be limited to 3 for the 3D magnetometer 210 to be able to sense a motion. Moreover, to receive a motion input having even a higher DOF from the pointing device used for inputting a person's operation, one accessory cooperates with other kinds of sensors available in the electrical device 2 to perform sensing and to figure out the motion having a higher DOE Under the presumption that data provided from at least two sensors are relevant to data obtained from one accessory and as a result of processing and analyzing the data, it is possible to sense a motion having a DOF corresponding to the sum of all the dimensions of the respective sensors.

The sixth example is an example of simple accessories having a magnet 110 introduced into a touch pen if as a typical stylus, in which a press input of a nib 150 against the touchscreen 230 together with magnetic field inputs by the magnetometer 210 are provided to receive an intuitive motion input in consideration of all DOFs. Those traditional touch pens are used for 2D sensing, which involves touching a point (x, y) on the touchscreen 230 operating under the electrostatic or static pressure mode employed for a portable computer. However, since the touch pen if itself is a cube placed in space, it also has 6 DOFs. Accordingly, by adding the magnet 110 for an additional reference to 3D magnetic field values of the magnetometer 210, the location of the nib 150 on the touchscreen 230 as well as the location and direction of the touch pen if as a cube in general are determined, thereby enabling a variety of inputs and gestures. In other words, when the nib 150 touches a point on the touchscreen 230, the control portion 280 confirms 3D information that lies on the touch position (x, y) of the nib 150 on the touchscreen 230 having a fixed height (z), and finds a complete location and angle of the 6-DOF touch pen 1f in 3D space upon the addition of a 3D vector input provided from the magnetometer 210. In addition, it is optionally possible to estimate 3D information in many spaces, from relative locations of the touchscreen 230 and magnetometer 210. The rotational angle of a pen holder 151 may be limited such that one side of the pen holder 151 of the cylindrical touch pen if is bent in the height direction of the cylinder to help the user hold the touch pen if conveniently with his or her thumb, and the control portion 280 uses these constraints and 3D information in order to check on which side of the electrical device 2 the user is located.

Usually, a majority of smart phones or tables in the art use either electrostatic touchscreen or static pressure touchscreen. As a result, the screens do not distinguish a press from the skin or a palm 300 from a press from the nib 150. This forces the user to write while holding his or her hand way above in the air, being careful not to touch the touchscreen with the skin or palm 300, which causes difficulties in writing letters naturally and nails sometimes may get in the way of the user's writing. However, in case of the touch pen 1f having the magnet 110 embedded therein as shown in FIG. 7, the additional magnetic field sensing makes it possible for the control portion 280 to identify a press of the nib 150 even if both the nib 150 and the palm 300 may have touched the touchscreen 230.

Further, as the control portion 280 may recognize the entire touch pen 1f as a cube, it may check the position of a clicked point as well as the direction and slope of the pen holder 151 and a degree of rotation of the touch pen if with respect to the pen holder 151. That is, the control portion 280 may provide intuitive and diverse user interfaces by using information about the displacement or rotation of the touch pen 1f, and information which indicates which input is of the touch pen if and which input is not of the touch pen if among many touches on the screen.

To begin with, the control portion 280 may measure a pen pressure, namely, a pressure applied to the touch pen if and reflect this measurement in the thickness of a pen stroke for example. Two possible ways to measure a pen pressure are as follows: 1) when the user presses the touch pen if strongly, the touch pen if tends to move in the vertical direction on the display portion 220, more specifically towards the index finger of the user. Then the control portion 280 may determine the pen pressure based on an angle formed in that direction. 2) If the nib 150 is made from a rubber material having an appropriate elasticity, the height of the magnet 110 changes by a force applied to the touch pen 1f. Then the control portion 280 may determine the pen pressure based on a change in the height of the magnet. This method 2) may be done very accurately by analyzing continuous motions of the touch pen 1f.

Meanwhile, an increase in the DOF makes it possible for a simultaneous input of many variables. While moving an object by dotting and dragging a pen (viewpoint pan), an angle formed between the pen and the screen is adjusted at the same time and the object (viewpoint) is zoomed in/out, or the pen is rotated simultaneously, thereby enabling an intuitive user interface for rotating the object (viewpoint). The slope angle of the pen during the zoom in/out operation is preferably as nearly perpendicular to the slope angle in the index finger direction that is determined by the control portion 280 for detecting a pen pressure. Moreover, a gesture-based input is possible as well. In other words, while touching with a pen, if the upper tip of the pen is laid in a linear direction or erected, it is recognized as zoom in/out, and the upper tip of the pen is rotated in a circular trajectory, thereby enabling the rotation thereof. Needless to say, this operation may be done intuitively on a multi-touchscreen by a user interface called rubber-banding using two fingers. However, considering a situation where the user who is already using a pen at the moment has to put the pen down and uses his or her fingers for rubber-banding and then pick up the pen again, the user interface of the disclosure is a far more swift and intuitive.

In an object creation or edit mode on the screen, even if the same dot seemed to be made, its effects could be manifested differently depending on an angle formed between the pen and an object or the screen. That is, when digging or pasting an object with a touch of the pen, the object may be dug or pasted at different angles depending on an angle of the pen. For instance, when the pen is rotated, the object may be curled up or turn into a different color accordingly.

The different between a touch from the touch pen if and a touch from the hand may be reflected in an input. For instance, suppose that a virtual rocket needs to be made in space. Then, the pen is used for displaying the location and angle of the rocket in a whole space, while at the same time the user can use two fingers to adjust wings of the rocket or the length of a gun attached thereto. As this is happening in multi-touch environment, multi-touches from different fingers, and multi-touches between a finger and the pen will naturally be distinguished and reflected in an input. Further, while the user may input using a finger, he or she can also write naturally, while one palm of the user is supporting the screen. This is made possible, based on the fact that the pen holder tends to tilt in a direction where the rest of the hand holding the pen is, and by measuring an angle between the thumb and the pen holder. That is, one could guess from the above fact that a touch input being made at a certain portion of the touchscreen where a palm of the user is going to be is ignored, and only a touch input on the opposite side is received. In this manner, both pen inputs and finger inputs may be made naturally, while a palm is still put on the screen.

In addition, other gestures of the touch pen if including, for example, shaking or overturning in the air above the touchscreen 220 without touching the touchscreen 230 are sensed by the magnetometer 210, and the control portion 280 recognizes a magnetic field vector or a change in the sensed magnetic field so as to perform corresponding data processing or screen processing. The control portion 280 may change an input mode. For example, whenever the touch pen 1f is overturned, the input mode may be switched to a write mode or an erase mode. Also, whenever the pen sways in a horizontal direction, the color of letters being written, or the size of an eraser for deleting the written letters may be changed. Moreover, whenever the pen sways in a vertical direction, the input mode may be changed into pen writing trajectory inputs or into rectangular, circle, straight line inputs. To be short, the control portion 280 may change the screen shown on the display portion 220, or change a setting value or setting environment in a program or app currently in operation, in response to a recognized gesture.

As shown in FIG. 7, instead of embedding a magnet in a stylus, it is possible to produce a small, simple accessory that is easy to attach and has a built-in magnet, and then attach this accessory to a normal touch pen. A user may use this as it is, or wear this on a finger as a ring. When using such a magnet ring worn on the index finger for touching, magnetic field information generated by a magnet in the ring is also obtained, in addition to the touch location. As such, it becomes easier to determine where was pressed by the tip of the index finger as intended by the user, even though many places on the touchscreen 230 may have been pressed with a palm and the tip of the index finger, the thumb or the like. Here, the prior physical information about the magnet ring being worn on the index finger is recognized by the control portion 280. Further, as already described in FIG. 6A, a higher DOF, intuitive inputs are now possible based on diverse angles and directions. When two people are looking at the same portable computer screen, i.e., one wearing the ring and the other not wearing the ring, it is useful for finding out who made a touch. For instance, in a game where players compete against each other for cutting incoming fruits, it may be useful for finding out who cuts those flying fruits the most. Also, the user may make more diverse inputs by distinguishing between the index finger and the other fingers.

The magnet ring described above may be applied for short writing with one hand, without necessarily taking a smart phone or tablet out of a handbag or a pocket, which is realized by making use of the penetration nature of a magnetic field. Although it is difficult to find a motion of the ring in a high DOF space only with the limited dimensional data, an estimate of the motion of a finger (although not accurate) may still be obtained from a few presumptions (prior physical information) and simple information (e.g., parked location, telephone number or the like) may be input when time presses. Meanwhile, in order to estimate a motion of the magnet inside the ring based on data from the magnetometer, a special presumption is used in regard to how the user's hand moves during writing. In one possible way, under the presumption that during writing, a pen and the fingers holding the pen tend to make nearly parallel motions, values that represent the user's writing style very well are substituted into ‘roll, pitch, yaw’ of a ring and then the location of the ring (x, y, z) is estimated to get the location of a pen stroke. Depending on how a smart phone is tilted, relative values of roll, pitch, and yaw change accordingly. Therefore, when the user writes something, values that are read by the accelerometer and the gyroscope in the smart phone are used for correcting an angle, so as to help the user write at a certain angle in a more convenient way. It is also important to detect whether the user is drawing a stroke or is simply moving to another start position for a next stroke. This may be determined by looking at z (that is, the height of the tip of a finger) among other components obtained from the presumption. Other presumptions are also possible; for example, if an estimated speed of the ring is fast it is regarded as a pen stroke, and if the speed is slow it is regarded as a motion. However, since the presumption that there will not be a much difference in heights and thus the motion will be generally parallel is not completely accurate either, instead of adopting a binary processing method, the control portion 280 preferably changes and outputs the thickness or color of a pen stroke depending on an estimated height or speed.

In addition, because the roll, yaw, pitch parameters used for the presumption (prior information) may vary significantly depending on a given situation, the electrical device 2 stores original magnetic field data obtained from the magnetometer, and then in case the user does not recognize, the electrical device 2 may estimate what the user wrote, modifying the parameters used for the presumption with the original data.

For the computer to estimate the location of a ring, drawing a stroke, a simple motion or the like, the electrical device 2 provides a preset presumption (prior information) to the user such that the user may be able to write according to given instructions. For instance, based on the presumption described above, the electrical device 2 may instruct the user to write without turning the pen too much, or to move fingers quickly with a force when writing, otherwise moving fingers slowly.

The pointing device with a magnet and the sensing method as discussed in FIG. 7 are not particularly limited to the pen or ring shape, and any tools of an oval shape or a thimble shape, having a magnet provided therein, may be applied to both handheld and attachment uses. Main features here include that the magnet and the touch are both used for a higher DOF, intuitive input, and as a result thereof, it is possible to receive an input of a high dimension corresponding to the sum of the number of limited dimensions of the magnetometer and the number of limited dimensions of the touchscreen. Also, under the presumption that a contact point sensed by the touchscreen and the magnet sensed by the magnetometer are either fixed with respect to each other in space or their relative motions are limited, the location of an object for input may be found more specifically.

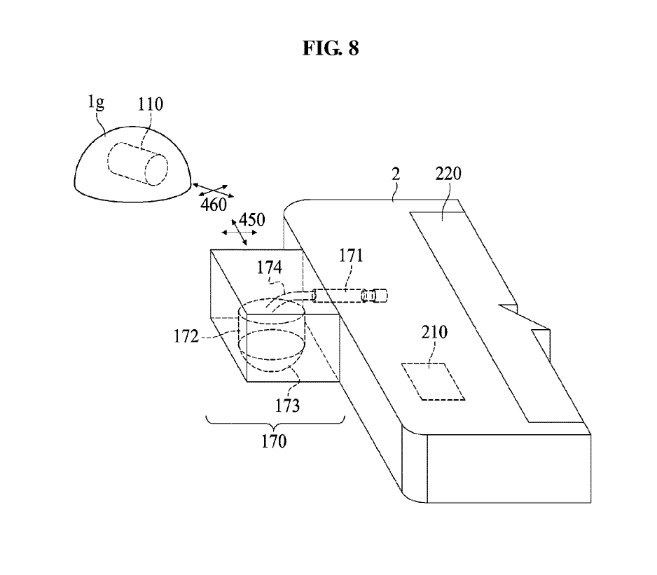

FIG. 8 is a diagram illustrating a seventh example of the user input system illustrated in FIG. 1.

FIG. 8 shows yet another example of the method of the present disclosure, in which an object 1g having a magnet 110 fixed therein is secured onto the plane, and the electrical device 2 is moved using one hand, similar to a mouse. Following this motion, the control portion 280 senses a change in the values of the magnetometer 210 as a function of a change in the location of the magnet 110 that moves relatively to the electrical device 2 so as to find how the electrical device 2 has been moved, and then performs a necessary operation, such as, changing the screen. As the user holds the electrical device 2 and drags it on the ground, the output thereof, such as, a cursor may be executed separately in a computer, and the motion of the electrical device 2 is transmitted to a separate computer through the communication portion 250 like WiFi or Bluetooth. In order to learn about the motions of the electrical device 2 from the magnetometer 210, there are limiting conditions that the object 1g having the magnet 110 needs to be fixed, and the electric device 2 needs to be dragged on the plane in an area close to the object 1g. Because the electrical device 2 remains in parallel with the plane where the magnet 110 is laid and the height of the magnetometer 210 on the ground is constant while the electrical device 2 is being dragged, the roll and pitch components and a DOF in a height difference (z) between the magnet 110 and the magnetometer 210 in the electrical device 2 disappear. Therefore, it becomes easier to derive (x, y, yaw) components from the values of a 3D magnetometer. Referring to the yaw component, the (x, y) coordinates obtained may be interpreted in the coordinate system 450 of the body of a phone, not in the coordinate system 460 of a magnet. In other words, regardless of an accessory 1 being laid on the plane at whatever angle, it is possible to interpret how much the accessory 1 has moved with respect to the vertical direction as well as to the horizontal direction 450.

What matters here is distinguishing between a state where the electrical device 2 is being dragged and a state where the electrical device 2 is picked up and delivered to a convenient location. Even when the electrical device 2 is dragged on the plane, after a certain point, the user often lifts the electrical device 2 and brings it to a more convenient location for manipulation and then drags it from there again. However, under the presumption that the electrical device 2 stays on the plane, the interpretation of measurement values from the magnetometer 210 does not tell whether or not the electrical device 2 has been held up in the air. If the electrical device 2 was actually held up in the air, based on the presumption described above, the control portion 280 may perform a calculation process, believing that the electrical device 2 has been dragged to a wrong location and in a wrong angle on the plane. Therefore, it is important to distinguish whether the electrical device 2 is being dragged, or is moving in the air.

This may be detected by combining the accelerometer and the gyroscope already present in most of smartphones. In other words, if the electrical device moves in a direction perpendicular to the gravity and then is influenced by a linear acceleration or rotation in a direction that is not perpendicular to the gravity, the control portion regards this as the electrical device being held up in the air. On the other hand, if the electrical device has landed on the ground and is influenced by a relatively large angular acceleration or linear acceleration, accompanied by vibrations, and then maintains a constant state with respect to the gravity direction, the control portion regards this as the electrical device being landed on the ground again. A smart phone without this accurate sensing function may employ an additional portion 170 provided with a plug 171 which is plugged in a headset jack of a portable computer, a microphone 172 electrically connected to the plug, facing the ground, and a solid portion 173 which scratches the ground as the phone scratches the ground and generates noise therefrom, the noise being inputted to a computer by the additional portion 170.

As in the example of FIG. 8, it is also important here to distinguish whether the electrical device 2 is being dragged on the ground or being held up in the air. To this end, the microphone 172 is provided to the bottom of the electrical device 2, and serves to recognize the dragging of the electrical device 2 on the ground as a sound. The microphone 172 is connected by a sufficiently long electric line 174, and a plug 171 where a headset jack of the electrical device 2 is plugged in is provided to the other end of the microphone. In the electrical device 2, therefore, any detected sound is transmitted to the control portion 280 through the acoustic receiving portion 270. As shown in FIG. 8, an acoustic acquisition portion 170 includes a body 173 for accommodating the microphone 172 therein, the microphone 172, and the electric line 174 for electrically connecting the microphone 172 and the plug 171.

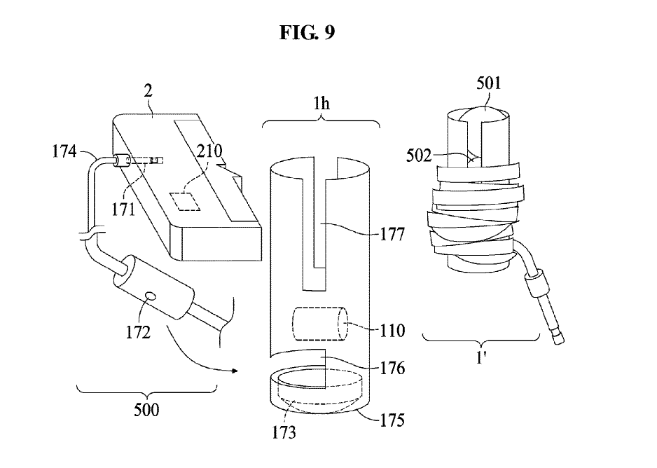

FIG. 9 is a diagram illustrating an eighth example of the user input system illustrated in FIG. 1.

To the user, the dragging sound on the ground may be very soft enough to be negligible, but the microphone 172 which is located nearby and receives a sound via a solid may sense a sufficiently large noise. The solid 173 which serves to generate such noise and transmit it to the microphone 172 may be made from diverse materials and provided to a bottom 175 of a mouse 1h. The electrical device 2 receives an input from the microphone 172 via the acoustic receiving portion 270, and decides whether the mouse 1h is being dragged. If not, the electrical device 2 does not move the cursor on the screen.

The mouse 1h is composed only of a magnet 110 and a simple body as shown in FIG. 9, without a separate microphone, an electric line, and a plug. In this case, the microphone 172 of a regular headset 500 the user owns is installed in an empty slit 176 at the lower end of the mouse 1h, a plug 171 of the headset 500 is plugged in the jack of the electrical device 2, and a sensed dragging sound of the mouse 1h on the ground is transmitted to the electrical device 2. The light, simple body of the mouse 1h may also serve as a housing around which a long, easily tangling line of the headset 500 may be wound and which receives an earbud 501 or plug to facilitate a convenient carry-on thereof. A long slit that looks like the one 177 may be formed for the aforementioned housing use, and to distinguish between the front and the rear of the mouse 1h. As this type of the mouse 1h is built in a small and simple structure, it may be used as a stylus that the user holds in hand and writes on the display portion 220 or a broad plane above the display portion 220. It would be obvious to a person skilled in the art that a portion to be dragged on the ground and a hand-held portion may be connected by materials or portions for promoting the flexibility thereof, thereby enabling adjustment of a grasping angle.

Sensing scratches based on the sound caught by a microphone may also be used for other applications of recognizing simple actions far away from a phone. For instance, suppose that a foot pedal motion made distant from an electrical device needs to be recognized. To this end, a microphone is installed inside the pedal such that one can hear a frictional sound generated between a stepped, a moving portion of the pedal, and a portion for supporting the same. This microphone has an electric line and a plug, and uses them to transmit large noise it picked up near the electrical device located at a certain distance. By analyzing this sound, the electrical device may find out whether the pedal has been stepped, or whether the pedal has been stepped and then released. The moving portion and the supporting portion of the pedal may be designed to have a rugged surface such that the frictional contact between them would be able to make large noise intentionally, and to have a rugged pattern in a certain direction such that the electrical device may distinguish different directions (e.g., whether the pedal has been stepped, or has been stepped and then released).

It is also possible to install a permanent magnet that moves and rotates mechanically by at least one electromagnet or motor fixed in the vicinity of an area where an object having such a magnet discussed in the present disclosure moves, and to generate a desired magnetic field whenever necessary, thereby pushing or pulling an accessory in a specific direction and implementing a force feedback therefrom.

If the user owns a variety of low-priced, simple structure accessories similar to ones described above, which may be recognized with a magnetometer or touchscreen of a portable computer, their applications are not limited only to those portable computers, but are preferably expanded to computing environments without an embedded magnetometer, including, for example, relatively large screen laptop computers or desktop computers, or to wide open spaces where a projection work can be performed. Preferably, this requires at least one magnetometer having limited dimensions, a micro controller for simple control uses, a power module for sampling and conducting a self-data analysis on magnetic field data produced by an accessory if necessary, and a peripheral sensor for transmitting the data through a universal communication module frequently used, including a USB, Bluetooth, or WiFi, for example. This peripheral device including the above magnetometer may further include a force feedback module as discussed before, or add an embedded-type trackpad or incorporate this with an existing trackpad to enable both touch inputs and magnetic field inputs at the same time. In addition, a number of such peripheral devices may be arranged in scattered locations in space, and instead of using an expensive data bus that supports synchronization among these distributed peripheral devices, sensed values at different points of time in each peripheral device are read and the trajectory of an accessory including a moving magnet according to known physical laws can be obtained. As such, diverse accessories and motion games involving a wide open space can be performed without the need to reinstall relevant equipment, but simply by changing relevant software (program or app).

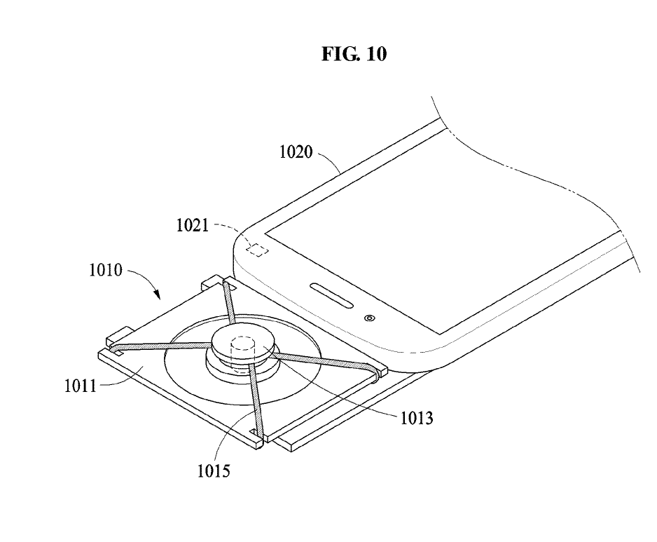

FIG. 10 is a diagram illustrating an input device according to an example embodiment.

Referring to FIG. 10, an input device 1010 includes a base portion 1011, a grip portion 1013, and an elastic member 1015. The input device 1010 may operate in an operation mode including, for example, a joystick mode in which the grip portion 1013 moves by a user while the grip portion 1013 is being in contact with the base portion 1011, and a slingshot mode in which the grip portion 1013 is located in a 3D space separated from the base portion 1011 and then released by the user.

The base portion 1011 is a portion fixed to a predetermined location of an electrical device 1020. For example, the base portion 1011 is fixed to a side face of the electrical device 1020 as illustrated. In addition, the base portion 1011 is fixed to be parallel to a display of the electrical device 1020.

The base portion 1011 may be a reference for a movement of the grip portion 1013 in the joystick mode. For example, the base portion 1011 includes a 2D plane, and an engraved portion that restricts a movement of the grip portion 1013 to be within a preset range.

The grip portion 1013 has a center-based regression characteristic to return to a predetermined location of the base portion 1011. The grip portion 1013 is a portion that may move and/or rotate based on a user input, and thus may return to the predetermined location when a user input about the grip portion 1013 is canceled.

The operation mode of the input device 1010 may change based on a movement of the grip portion 1013. For example, in a case in which the grip portion 1013 moves by the user while the grip portion 1013 is being in contact with the base portion 1011, the input device 1010 operates in the joystick mode. In addition, in a case in which the grip portion 1013 moves to the 3D space separated from the base portion 1011 by the user, the input device 1010 operates in the slingshot mode. Here, when the user releases the grip portion 1013, the grip portion 1013 rapidly returns to the predetermined location.

In one example, the grip portion 1013 includes a magnetic field generator. The magnetic field generator refers to a portion that generates a magnetic field and includes a magnet, for example, a permanent magnet and an electromagnet. A magnetic field generated from the magnetic field generator is detected by a magnetometer 1021 in the electrical device 1020. Here, a magnetic field vector detected from the magnetic field generator may have m dimensions, and the grip portion 1013 may have an n-DOF, wherein n is greater than m (n>m). For example, the magnetic field generator may be a permanent magnet or an electromagnet, which is illustrated by a broken line in the grip portion 1013 in FIG. 10.

The elastic member 1015 refers to a portion that connects the base portion 1011 and the grip portion 1013. Through the elastic member 1015, the grip portion 1013 may have the center-based regression characteristic. That is, the elastic member 1015 is connected to symmetrical points of the grip portion 1013 such that the grip portion 1013 may return to the predetermined location of the base portion 1011 in the absence of a user input about the grip portion 1013. The elastic member 1015 refers to a member having elasticity, for example, a rubber band.

That is, the grip portion 1013 and the base portion 1011 are connected by the elastic member 1015, and thus the grip portion 1013 may rapidly return to an original location when the user releases the grip portion 1013 after separating the grip portion 1013 from the base portion 1011 and moving the grip portion 1013 in a 3D space while holding the grip portion 1013. Here, the original location of the grip portion 1013 refers to a location at which the grip portion 1013 is located in the absence of a user input about the grip portion 1013.

Here, a trigger that generates an event, for example, shooting a slingshot gun, an arrow, and a gun in game contents, to operate the electrical device 1020 may be used by recognizing such a rapid return of the grip portion 1013 through various sensors, for example, the magnetometer 1021 and an image sensor. When the trigger is pulled, for example, when the user releases the grip portion 1013 located in the 3D space separated from the base portion 1011, a direction in which, for example, an arrow flies or a distance, or alternatively, a speed and an acceleration rate, of the flying may be determined based on a location in the 3D space at which the grip portion 1013 is located immediately before the trigger is pulled. For example, the direction and the distance of the flying of the arrow may be determined, respectively, using a direction and a distance from the location of the grip portion 1013 in the 3D space to the original location of the grip portion 1013. The distance of the flying of the arrow may be determined to be proportional to the distance from the location of the grip portion 1013 in the 3D space to the original location of the grip portion 1013.

The input device 1010 described above is also referred to as a slingshot joystick. The slingshot joystick includes the magnetic field generator, for example, a permanent magnet and an electromagnet, and the electrical device 1020 receives a user input from the slingshot joystick using the magnetic field vector detected by the magnetometer 1021 from the magnetic field generator. Alternatively, the slingshot joystick may be embodied using a magnetic field generator included in the grip portion 1013 and a magnetometer fixed to the base portion 1011, for example, the magnetometer 1021 in the electrical device 1020 fixed to the base portion 1011.

By measuring the location of the grip portion 1013 by the magnetometer 1021, a joystick manipulation may be recognized in the base portion 1011 or a location at which the grip portion 1013 is lifted in the 3D space may be determined. Also, a slingshot manipulation may be recognized based on a change in a magnetic field vector that is rapidly changed when the grip portion 1013 is released after being pulled.

In another example, the grip portion 1013 includes a magnetometer and the base portion 1011 includes a magnetic field generator, for example, a permanent magnet and an electromagnet, and the joystick manipulation or the slingshot manipulation may be recognized using a magnetic field vector detected by the magnetometer in the grip portion 1013.

In still another example, both the base portion 1011 and the grip portion 1013 include magnetic field generators, and the center-based regression characteristic of the grip portion 1013 may be embodied by an electromagnetic attractive force between the magnetic field generators included in the base portion 1011 and the grip portion 1013. That is, in a case in which the user releases the grip portion 1013 after moving the grip portion 1013 being in contact with the base portion 1011 or the user releases the grip portion 1013 located in the 3D space separated from the base portion 1011, the grip portion 1013 may return to the original location of the grip portion 1013 by such an electromagnetic attractive force. In such an example, the elastic member 1015 illustrated in FIG. 10 may be omitted.

In one example, a displacement or a rotation of the grip portion 1013 is determined based on prior physical information of the input device 1010 and the magnetic field vector detected from the magnetic field generator by the magnetometer 1021 in the electrical device 1020. The electrical device 1020 determines the displacement or the rotation of the grip portion 1013, and thus receives a user input from the input device 1010. The electrical device 1020 may be a computing device, for example, a smartphone, a tablet, a laptop computer, a computer.

The prior physical information of the input device 1010 includes at least one of information associated with the predetermined location in the electrical device 1020 to which the base portion 1011 is fixed or restriction information associated with a restriction on a movement of the grip portion 1013.

The restriction information associated with the restriction on a movement of the grip portion 1013 includes at least one of information associated with a movable range in which the grip portion 1013 moves while being in contact with the base portion 1011 by a user input and an available location range in which the grip portion 1013 is separated from the base portion 1011 and located in the 3D space, or information associated with the original location at which the grip portion 1013 is located in the absence of a user input about the grip portion 1013. In addition, the restriction information associated with the restriction on a movement of the grip portion 1013 further includes information associated with an available direction in which the grip portion 1013 is separated from the base portion 1011.

In another example, the grip portion 1013 includes a light-emitting diode (LED) that emits light, or a visual marker. Thus, a location of the grip portion 1013 may be measured by detecting light from the grip portion 1013 through the image sensor fixed to the base portion 1011 or identifying the visual marker of the grip portion 1013. Here, the image sensor may be disposed under the base portion 1011 that is transparent or semi-transparent.

The preceding description is provided based on the magnetometer 1021 for convenience of description. However, a scope of example embodiments of the present disclosure is not limited to the preceding description, and any one of an image sensor and a depth sensor in addition to the magnetometer 1021 may be used without limitation. However, for convenience of description, the description is provided herein based on the magnetometer 1021.

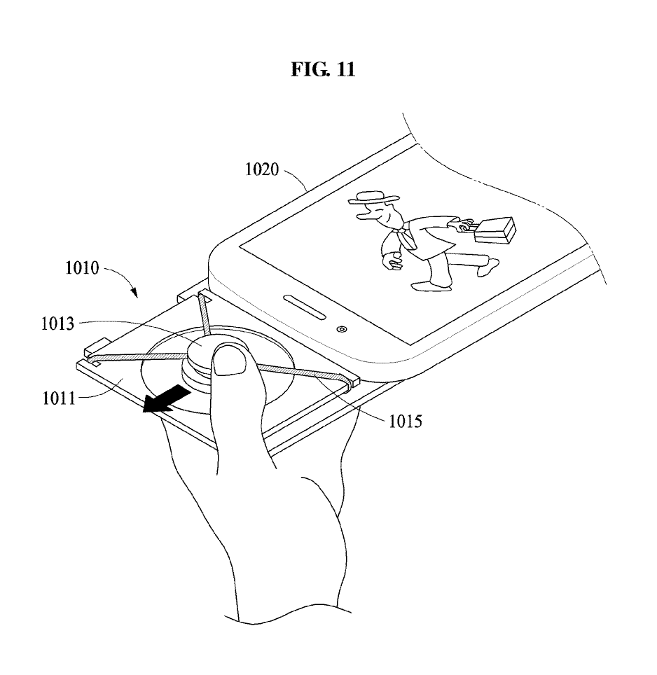

FIG. 11 is a diagram illustrating a joystick mode of an input device according to an example embodiment.

In one example, an input device 1010 operates in a joystick mode in which a grip portion 1013 moves while being in contact with a base portion 1011. In such an example, a location and/or an angle at which the grip portion 1013 is bent or pushed by a hand of a user while the grip portion 1013 is being attached to the base portion 1011 may be measured through a magnetometer in an electrical device 1020, and the location and/or the angle at which the grip portion 1013 is bent or pushed may be used as a user input that operates or manipulates the electrical device 1020.

In a case in which a target to be controlled by the input device 1010 is a virtual object, for example, a game character, in a virtual reality or an augmented reality, which is displayed on the electrical device 1020, or a remote object to be controlled by the electrical device 1020, for example, a drone, an RC robot, an RC vehicle, an RC helicopter, and an RC airplane, a displacement of the virtual object or the remote object or an orientation at which the virtual object or the remote object views may be controlled through an operation of bending or pushing the grip portion 1013 while the grip portion 1013 is being in contact with the base portion 1011.

For example, as the grip portion 1013 is separated farther apart from an original location of the grip portion 1013 while the grip portion 1013 is being in contact with the base portion 1011, a moving speed of the virtual object or the remote object to be controlled in the electrical device 1020 may increase.

In a case in which the user pushes the grip portion 1013 leftwards while the grip portion 1013 is being in contact with the base portion 1011, a right portion of an elastic member 1015 that is disposed on a right side of the grip portion 1013 may have a greater tension than a left portion of the elastic member 1015 that is disposed on a left side of the grip portion 1013. Thus, in a case in which the user releases the grip portion 1013 after pushing the grip portion 1013 leftwards while the grip portion 1013 is being in contact with the base portion 1011, the grip portion 1013 that is pushed leftwards may return to the original location of the grip portion 1013 by moving rightwards by a tension of the elastic member 1015.

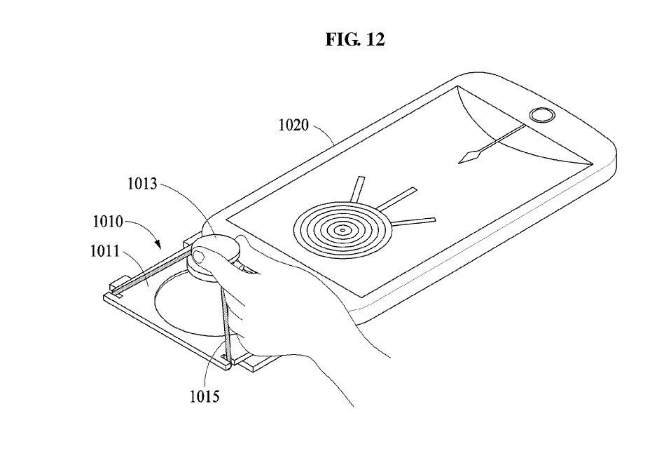

FIG. 12 is a diagram illustrating a slingshot mode of an input device according to an example embodiment.

In one example, an input device 1010 operates in a slingshot mode in which a grip portion 1013 is located in a 3D space separated from a base portion 1011 and then released by a user.

For example, the user may grab the grip portion 1013 and take off the grip portion 1013 from the base portion 1011 to dispose the grip portion 1013 in the 3D space separated from the base portion 1011. In such an example, a location and/or an angle of the grip portion 1013 in the 3D space separated from the base portion 1011 may be measured by a magnetometer in an electrical device 1020, and the measured location and/or the angle of the grip portion 1013 in the 3D space may be used as a user input to manipulate or operate the electrical device 1020.

Here, a user input in the slingshot mode may differ from a user input in a joystick mode. That is, the user input of disposing the grip portion 1013 in the 3D space separated from the base portion 1011, and the user input of moving the grip portion 1013 being in contact with the base portion 1011 may induce different types of operations in the electrical device 1020.

For example, in a case in which the grip portion 1013 moves while being in contact with the base portion 1011, an operation that a virtual object or a remote object to be controlled in the electrical device 1020 moves accordingly may be performed. In a case in which the grip portion 1013 is separated from the base portion 1011, an operation that the virtual object or the remote object to be controlled in the electrical device 1030 jumps or rotates accordingly may be performed, or an operation that an orientation or an angle at which a slingshot gun, an arrow, or a gun views is changed based on a location of the grip portion 1013 in the 3D space may be performed. In the electrical device 1020, the virtual object or the remote object may jump to a height proportional to a distance between the base portion 1011 and the grip portion 1013. That is, in the joystick mode, when the grip portion 1013 is separated from the base portion 1011 by the user, the virtual object or the remote object that is walking or running on the ground may be separated from the ground and then jump based on a direction and a height of such a separation. In a case in which such a movement of the grip portion 1013 being separated from the base portion 1011 induces the jumping of the virtual object or the remote object, the virtual object or the remote object may be afloat in the space and change a flight direction and a viewing direction based on a change in a location and an angle of the grip portion 1013 while the user continues grabbing the grip portion 1013 in the space. In addition, in a case in which the grip portion 1013 is continuously separated even after the virtual object or the remote object returns to the ground by gravity, a subsequent movement of the virtual object or the remote object may be controlled based on a location at which the grip portion 1013 is afloat or a direction in which the grip portion 1013 is afloat.

In a case in which the user releases the grip portion 1013 located in the 3D space separated from the base portion 1011, the grip portion 1013 may return to the base portion 1011 at a high speed to be attached to the base portion 1011 by an elastic member 1015 or an electromagnetic attractive force.

Here, by recognizing such a rapid return of the grip portion 1013 through various sensors such as a magnetometer and an image sensor (e.g., camera), a subsequent operation of the electrical device 1020 may be derived by a user input to dispose the grip portion 1013 in the 3D space. For example, such an operation in which the grip portion 1013 located in the 3D space rapidly returns may be used as a trigger to generate a certain event, for example, shooting a slingshot gun, an arrow, and a gun. Here, a direction and a distance of a gun or an arrow flies, or a speed and an acceleration rate at which the gun or the arrow flies when the trigger is pulled may be determined based on a location of the grip portion 1013 in the 3D space immediately before the trigger is pulled.

For example, based on a direction and a distance of the arrow actually being pulled to a location of the grip portion 1013 in the 3D space separated from the base portion 1011, an arrow that is pulled by a virtual object or a remote object to be controlled in the electrical device 1020 may fly.

As described above, the joystick mode and the slingshot mode of the input device 1010 may be determined based on whether the grip portion 1013 is attached to the base portion 1011 or separated from the base portion 1011 while being afloat in the 3D space. The joystick mode and the slingshot mode may be distinguished from each other through various methods.

In one example, a positive (+) electrode and a negative (−) electrode may be disposed on an area in the base portion 1011 in which the grip portion 1013 touches and moves. Here, the electrodes may have a preset magnitude of a potential difference, or be disposed separately from each other by a preset distance with a preset magnitude of a potential difference. In a case in which a surface of the grip portion 1013 that is in contact with the base portion 1011 is a conductor, the potential difference between the two electrodes may be reduced when the grip portion 1013 comes in contact with the base portion 1011. Based on such a principle, whether the grip portion 1013 touches the base portion 1011 may be determined by measuring the potential difference between the two electrodes, and thus whether the grip portion 1013 is in contact with the base portion 1011 may be determined. For example, in response to the potential difference between the two electrodes being less than or equal to a preset value, whether the grip portion 1013 is in contact with the base portion 1011 may be determined.

In another example, by installing, under the base portion 1011, a sensor configured to sense a capacitance or a capacitive pressure, instead of using the potential different or a phase difference between the two electrodes, whether the grip portion 1013 is in contact with the base portion 1011 may be determined based on a change in the capacitance or the capacitive pressure by the grip portion 1013.

In still another example, whether the grip portion 1013 is in contact with the base portion 1011 may be determined by measuring a location of the grip portion 1013. For example, in a case in which the grip portion 1013 includes a magnetic field generator, and a location and/or a direction of the grip portion 1013 is determined by detecting a magnetic field vector from the magnetic field generator by at least one magnetometer fixed to the base portion 1011, whether the grip portion 1013 is in contact with the base portion 1011 may be determined through the following method.

For example, by setting, as a reference coordinate system, a coordinate system defined by three axes x, y, and z vertical to the magnetometer, a plane equation of the base portion 1011 may be represented by Equation 5.

Ax+By+Cz+E=0 [Equation 5]

Under the assumption that a central location of the grip portion 1013 in the reference coordinate system, which is measured by the magnetometer, is (xf, yf, zf), a distance D between the central location of the grip portion 1013 and the base portion 1011 in the 3D space may be calculated as follows using the central location (xf, yf, zf) and the plane equation. The central location of the grip portion 1013 denotes a central point in the grip portion 1013, and the magnetic field generator may be located at such a point.

$$D = \frac{\vert {Ax}_{f} + {By}_{f} + {Cz}_{f} + E \vert}{\sqrt{{A}^{2} + {B}^{2} + {C}^{2}}} \qquad [ Equation 6 ]$$

In response to the distance D being equal to a distance between the central location of the grip portion 1013 and the surface of the grip portion 1013 touching the base portion 1011, it may be determined that the grip portion 1013 is in contact with the base portion 1011. In response to the distance D being greater than the distance between the central location and the surface on which the grip portion 1013 touches the base portion 1011, it may be determined that the grip portion 1013 is not in contact with the base portion 1011.

That is, whether the grip portion 1013 is in contact with the base portion 1011 may be determined using a distance between the central location of the grip portion 1013 and the base portion 1011, which is measured by the magnetometer.

Additionally, whether the grip portion 1013 is in contact with the base portion 1011 may be determined further based on at least one of a difference between an arrangement direction of the base portion 1011 and an arrangement direction of the grip portion 1013, or a distance between a current location of the grip portion 1013 and the original location of the grip portion 1013 at which the grip portion 1013 is located in the absence of a user input about the grip portion 1013.

For example, the difference between the arrangement direction of the base portion 1011 and the arrangement direction of the grip portion 1013 may be determined based on a difference between a normal vector of the base portion 1011 and a normal vector of the surface of the grip portion 1013 on which the grip portion 1013 touches the base portion 1011. Here, in response to the difference between the normal vector of the base portion 1011 and the normal vector of the surface being less than or equal to a preset reference value, it may be determined that the base portion 1011 and the surface of the grip portion 1013 on which the grip portion 1013 touches the base portion 1011 are parallel to each other, and the grip portion 1013 is in contact with the base portion 1011 accordingly.

In addition, it may be determined that the grip portion 1013 is in contact with the base portion 1011 when the distance between the current location of the grip portion 1013 and the original location of the grip portion 1013, for example, (x0, y0, z0), at which the grip portion 1013 is located in the absence of a user input about the grip portion 1013, is less than or equal to a preset reference value.

In one example, an image sensor (e.g., camera) may be disposed on a rear face of the electrical device 1020, and a display (e.g., general-type screen and touchscreen) may be disposed on a front face of the electrical device 1020. A displacement and/or a location of the grip portion 1013 may be determined using a magnetic field vector generated from the magnetic field generator in the grip portion 1013 and detected by the magnetometer in the electrical device 1020, and using prior physical information of the input device 1010.

Here, whether the grip portion 1013 and the base portion 1011 are attached to each other, and a location of the grip portion 1013 when the portions are attached to each other, may be determined using the prior physical information. In response to the grip portion 1013 and the base portion 1011 being attached to each other, a direction toward which the magnetic field generator in the grip portion 1013 proceeds in the 3D space may be the same as a normal vector direction of the base portion 1011, for example, a certain constant, and the grip portion 1013 and the base portion 1011 may be separated from each other by the distance D as represented in Equation 6. Using such prior physical information and a 3D magnetic field vector measured by a triaxial magnetometer of the electrical device 1020, a location of the grip portion 1013 relative to the base portion 1011 may be determined. The 3D magnetic field vector measured by the magnetometer, for example, (Bx, By, Bz), may be determined based on which location (xf, yf, zf) and which 2D angle (theta, phi) a dipole of the magnetic field generator has in the reference coordinate system based on the magnetometer. The following non-linear equation B numerically represents a magnetic field magnitude in a space.

(Bx,By,Bz)=B(xf,yf,zf,theta,phi) [Equation 7]

In Equation 7, theta and phi denote constants that are known by the prior physical information as described above, and thus may be excluded from Equation 7.

(Bx,By,Bz)=B(xf,yf,zf) [Equation 8]

In Equation 8, (x, y, z) corresponding to the magnetic field vector (Bx, By, Bz) measured by the magnetometer may be determined by substituting the measured magnetic field vector (Bx, By, Bz) to Equation 8 and performing a non-linear optimization on Equation 8. That is, a control portion of the electrical device 1020 may calculate a central location (x, y, z) of the magnetic field generator at which a difference between the actually measured magnetic field vector (Bx, By, Bz) and the magnetic field magnitude calculated through the function B is minimized.

Also, the control portion of the electrical device 1020 may calculate the central location (xf, yf, zf) of the magnetic field generator using a numerical analysis algorithm used to obtain a resulting value of three simultaneous equations with three variables in addition to the non-linear optimization. In addition, the control portion may measure, in advance, a magnetic field vector that may be detected from a possible location and direction vector of the magnetic field generator and store the measured magnetic field vector in a data table, and obtain a value most approximate to a magnetic field vector actually detected by the magnetometer and determine the central location (xf, yf, zf) corresponding to the obtained value. Alternatively, the control portion may determine the central location (xf, yf, zf) of the magnetic field generator using various methods, for example, a method of interpolating a plurality of candidate values that is obtained as described in the foregoing.

A location of the grip portion 1013 located in the 3D space separated from the base portion 1011 may be determined as follows:

1) A magnetometer configured to measure a 3-DOF of at least one magnetometer in the electrical device 1020 may be provided.

2) In a reference coordinate system based on the magnetometer in the electrical device 1020, a tilted azimuthal angle (phi) and a tilted longitudinal angle (theta) of the magnetic field generator of the grip portion 1013 of the input device 1010 may be mostly constant even in a state in which the grip portion 1013 is lifted, and the electrical device 1020 may store information associated with such angles, for example, theta and phi. Here, theta and phi denote pitch and roll, respectively, of the magnetic field generator. In a case of the magnetic field generator being a cylindrical magnet, the magnetometer may not detect a change in yaw of the magnetic field generator, and thus yaw may not be considered in such a case.

In such a case, the magnetic field generator of the input device 1010 may determine a movement in a 3-DOF, for example, a change in the central location (x, y, z) of the magnetic field generator, in a situation in which theta and phi are constant in general. Thus, the control portion of the electrical device 1020 may determine a central location of the magnetic field generator, which is most suitable to a 3D magnetic field vector detected by the magnetometer using the non-linear optimization or the non-linear equation as described in the foregoing. That is, the control portion of the electrical device 1020 may determine the central location of the magnetic field generator by applying the 3D magnetic field vector detected by the magnetometer to the non-linear optimization or the non-linear equation.

In one example, based on a 3D location of the magnetic field generator, which is calculated using the reference coordinate system determined based on the magnetometer embedded in the electrical device 1020, a display of the electrical device 1020 may perform rendering on the grip portion 1013 including the magnetic field generator. Through such rendering, that a virtual grip portion is pulled towards a location corresponding to the grip portion 1013 may be displayed in real time on the display during a user pulling the grip portion 1013, and thus the user may be provided with a sense of unity as if the user directly controls the virtual grip portion displayed on the display.

In addition, an image sensor (e.g., camera) may be disposed on a rear face opposite to a front face on which the display is disposed in the electrical device 1020. That is, a capturing direction of the image sensor may generally correspond to a direction in which a user views. The electrical device 1020 may display, in real time on the display, an entirety or a portion of an image captured by the image sensor disposed on the rear face, and thus provide the user with an experience of viewing an actual situation unfolded in front of the user through the display of the electrical device 1020.

The display of the electrical device 1020 may further display, on the image, a target the user needs to hit, for example, a virtual object (e.g., a mark, an object, a character, and a game). In detail, a location at which the target is to be displayed may be determined by referring to a location of some objects included in the captured image by analyzing and recognizing the image captured by the image sensor using a artificial intelligence algorithm to be performed in computer software. For example, a character corresponding to the target may be displayed as if the character runs around on a desk in the captured image.

In one example, in a case in which a user releases the grip portion 1013 after pulling the grip portion 1013, the grip portion 1013 rapidly returns to the base portion 1011 based on the center-based regression characteristic due to elasticity of the elastic member 1015. The electrical device 1020 recognizes an event indicating that the user releases the grip portion 1013 through a rapid change in a magnetic field vector detected by the magnetometer, and displays, on the display, a virtual grip portion, or a stone or a bullet that is loaded in the grip portion 1013, flying accordingly.

Here, a direction or a trajectory of the flying of the grip portion 1013 is calculated based on the prior physical information described above with reference to FIG. 3. The direction or the trajectory of the flying of the grip portion 1013 is determined using an elastic force affecting the grip portion 1013 based on a location of the grip portion 1013 immediately before the user releases the grip portion 1013 and a location to which the elastic member 1015 is fixed.

In a case in which an aiming target is in the determined direction or on the determined trajectory of the flying, the electrical device 1020 displays an event indicating that the target is hit and/or outputs sound and/or vibration corresponding to the event.

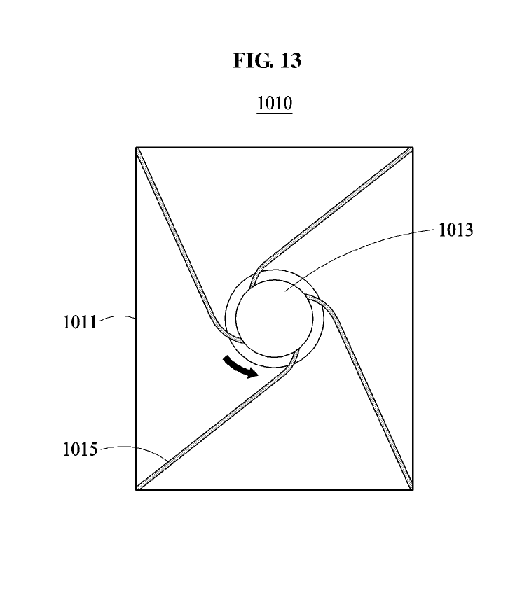

FIG. 13 is a diagram illustrating an operation of rotating a grip portion of an input device according to an example embodiment.

In one example, a user rotates a grip portion 1013 counterclockwise or clockwise while grabbing the grip portion 1013. As illustrated in FIG. 13, the user rotates the grip portion 1013 counterclockwise while grabbing the grip portion 1013.

A user input of rotating the grip portion 1013 on an axis vertical to a base portion 1011 may induce an operation that is different from operations induced by a user input of moving the grip portion 1013 in contact with the base portion 1011 and a user input of disposing the grip portion 1013 in a 3D space separated from the base portion 1011.

For example, in a case in which the user rotates the grip portion 1013 counterclockwise or clockwise while grabbing the grip portion 1013, a virtual object or a remote object to be controlled by an electrical device may rotate based on such a direction, or a viewpoint of a screen displayed on the electrical device may be changed based on the direction.

Since a distinguishable magnetic field needs to be applied to a magnetometer based on a rotation of the grip portion 1013, a dipole penetrating through N and S poles of a magnetic field generator in the grip portion 1013 may be disposed at a location and an angle that are distinguished from a central axis on which the grip portion 1013 rotates. Based on such a disposition, the magnetometer may detect a magnetic field that is distinguished by the rotation of the grip portion 1013 from the magnetic field generator configured to generate a rotationally symmetrical magnetic field based on the dipole as an axis.

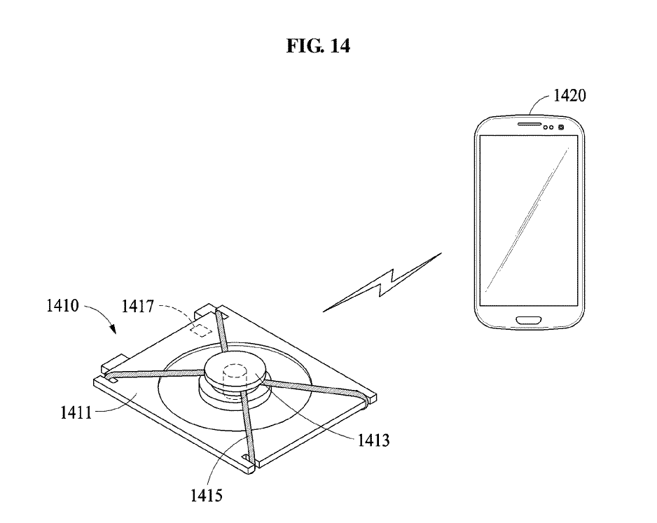

FIG. 14 is a diagram illustrating another type of an input device according to an example embodiment.

In one example, an input device 1410 may an independent device that is not attached to an electrical device 1420. Referring to FIG. 14, the input device 1410 includes a base portion 1411 and a grip portion 1413. The base portion 1411 and the grip portion 1413 are connected by an elastic member 1415.

The base portion 1411 is a reference structure for a movement of the grip portion 1413. For example, the base portion 1411 includes a 2D plane including an engraved portion to restrict a movement of the grip portion 1413 to a preset range.

The grip portion 1413 has a center-based regression characteristic to return to a predetermined location of the base portion 1411. The grip portion 1413 may move and/or rotate based on a user input, and may move while being in contact with the base portion 1411 or move to be located in a 3D space separated from the base portion 1411.

The elastic member 1415 refers to a member provided to connect the base portion 1411 and the grip portion 1413. The grip portion 1413 may have the center-based regression characteristic through the elastic member 1415. The elastic member 1015 is connected to symmetrical points of the grip portion 1013 such that the grip portion 1013 may return to the predetermined location of the base portion 1011 in the absence of a user input about the grip portion 1413. The elastic member 1415 is a member having elasticity, for example, a rubber band.

Since the input device 1410 is used independently without being attached to the electrical device 1420, the input device 1410 further includes a sensor 1417.

The sensor 1417 refers to a device configured to detect a relative movement between the base portion 1411 and the grip portion 1413 and includes, for example, a magnetometer, an image sensor, and a depth sensor.

The sensor 1417 is included in the base portion 1411 and detects a movement of the grip portion 1413. For example, in a case of the sensor 1417 being a magnetometer, the sensor 1417 detects a magnetic field vector from a magnetic field generator included in the grip portion 1413. Alternatively, in a case of the sensor 1417 being an image sensor, the sensor 1417 outputs an image obtained by capturing an image of the grip portion 1413. Alternatively, in a case of the sensor 1417 being a depth sensor, the sensor 1417 outputs depth information of the grip portion 1413.

In one example, the sensor 1417 includes two magnetometers, and excludes an influence of an external magnetic field. For example, the external magnetic field may be an earth magnetic field with a 3-DOF. Thus, in a case of the input device 1410 operating in a joystick mode, a magnetometer with five or higher dimensions may be used to detect a total of a 5-DOF including a 2-DOF for a movement of the grip portion 1413 and the 3-DOF for the external magnetic field.

In another example, in a case of the sensor 1417 being an image sensor or a depth sensor, the sensor 1417 is disposed under the grip portion 1413 on a same vertical axis as an original location of the grip portion 1413, and detects an accurate movement of the grip portion 1413. In such a case, the base portion 1411 is provided as a transparent plate, and the grip portion 1413 includes an LED or a visual marker.

In still another example, the sensor 1417 is included in the grip portion 1413. In such an example, the base portion 1411 includes a magnetic field generator, an LED, or a visual marker.

As described above, the input device 1410 may operate in the joystick mode or a slingshot mode. For example, the input device 1410 operates in the joystick mode in which the grip portion 1413 moves while being in contact with the base portion 1411, and operates in the slingshot mode in which the grip portion 1413 is released by the user after being located in a 3D space separated from the base portion 1411.

Here, whether the input device 1410 operates in the joystick mode or the slingshot mode, and a displacement and/or a rotation of the grip portion 1413 in a corresponding mode are determined based on a value sensed by the sensor 1417 and on prior physical information. For a detailed description, reference may be made to the descriptions provided with reference to FIGS. 10 through 13, and thus a more detailed and repeated description will be omitted here for brevity.

In one example, the input device 1410 transfers a user input to the electrical device 1420 by transmitting information associated with the determined displacement and/or rotation of the grip portion 1413 to the electrical device 1420 through wireless communication, for example, Bluetooth and WiFi, or wired communication.

In another example, the input device 1410 transmits, to the electrical device 1420 through wireless or wired communication, a value output from the sensor 1417 or information derived from a relative movement between the base portion 1411 and the grip portion 1413, and the electrical device 1420 determines a displacement and/or a rotation of the grip portion 1413.

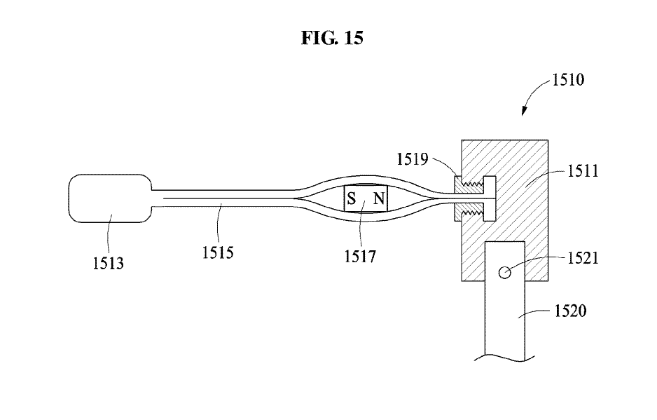

FIGS. 15 through 17 are diagrams illustrating an input device according to another example embodiment.

Referring to FIG. 15, an input device 1510 includes a base portion 1511, a grip portion 1513, an elastic member 1515, and a magnetic field generator 1517. The input device 1510 transfers a user input to an electrical device 1520 through an operation of pulling the grip portion 1513 far from the base portion 1511 and then releasing the grip portion 1513 by a user. The input device 1510 described here is also referred to as a slingshot gun.

The base portion 1511 is a portion fixed to a predetermined location of the electrical device 1520. For example, the base portion 1511 is fixed to a side face of the electrical device 1520 as illustrated.

The grip portion 1513 has a regression characteristic to return to a predetermined location of the base portion 1511. In a case in which the user pulls the grip portion 1513 far from the base portion 1511 and then releases the grip portion 1513, the grip portion 1513 returns to the base portion 1511 at a high speed due to the regression characteristic.

The elastic member 1515 is a member used to connect the base portion 1511 and the grip portion 1513. In a case in which the user pulls out the grip portion 1513 from the base portion 1511 by a length greater than a preset reference length and then releases the grip portion 1513, the length returns to an original length. That is, the elastic member 1515 may allow the grip portion 1513 to return to the predetermined location of the base portion 1511 in the absence of a user input about the grip portion 1513. The elastic member 1515 refers to a member having elasticity, for example, a rubber band. The elastic member 1515 is fixed to the base portion 1511 through a fastener 1519 as illustrated.

The magnetic field generator 1517 is a portion configured to generate a magnetic field and includes, for example, a permanent magnet and an electromagnet. The magnetic field generated by the magnetic field generator 1517 is detected by a magnetometer 1521 in the electrical device 1520.

In a case in which the user pulls the grip portion 1513 including the magnetic field generator 1517, the magnetic field generator 1517 becomes far apart from the magnetometer 1521, and a magnetic field to be generated may be rapidly reduced in inverse proportion to a cube of a distance. Due to such a characteristic of the magnetic field, a large magnet that may generate a strong magnetic field needs to be used or a range in which the grip portion 1513 is pulled needs to be narrowed. However, in a case of using the large magnet, the large magnet may be closely attached to a nearby iron and not be detached from the iron, or may cause damage to a nearby magnetic strip. In addition, in a case in which the range of pulling the grip portion 1513 is narrowed, a hand of the user grabbing the grip portion 1513 may approach a display of the electrical device 1520, and thus the display may be covered by the hand of the user.

Thus, it may be desirable to pull the grip portion 1513 farther while using a small magnet. This may be achieved through a structure in which the grip portion 1513 and the magnetic field generator 1517 are separated from each other, and the base portion 1511, the grip portion 1513, and the magnetic field generator 1517 are connected through the elastic member 1515. That is, the base portion 1511 and the magnetic field generator 1517 are connected through the elastic member 1515, and the magnetic field generator 1517 and the grip portion 1513 are connected through the elastic member 1515. Alternatively, as illustrated in FIG. 14, the base portion 1511, the grip portion 1513, and the magnetic field generator 1517 are connected through the elastic member 1515 to be as a single pipe. In such a case, the grip portion 1513 and the elastic member 1515 may be provided as an integral type.

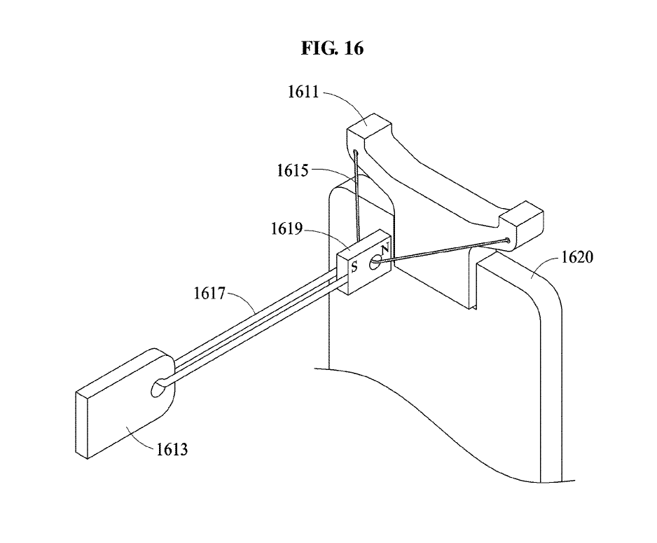

Alternatively, as illustrated in FIG. 16, a base portion 1611 and a magnetic field generator 1619 are connected through a first elastic member 1615, and a grip portion 1613 and the magnetic field generator 1619 are connected through a second elastic member 1617. Using such a structure, a force of pulling the grip portion 1613 may be distributed at a ratio between the base portion 1611 and the magnetic field generator 1619, and the magnetic field generator 1619 and the grip portion 1613. The magnetic field generator 1619 may thus be pulled at a preset ratio to a distance by which the grip portion 1613 is pulled. Thus, using a location of the magnetic field generator 1619 and the preset ratio, which is determined as described with reference to FIG. 12, a 3D location of the grip portion 1613 may be determined. In addition, the distance by which the grip portion 1613 is pulled may be determined. Through such a structure, the magnetic field 1619 may not be separated, by a considerably great distance, from a magnetometer of an electrical device 1620. Thus, it may be possible to use a small magnet, and at the same time, provide a user with an experience of pulling a slingshot gun far away without covering a display.

To determine a location of the grip portion 1613 or the magnetic field generator 1619, an influence of an external magnetic field, for example, earth magnetic field, needs to be considered. To consider such an external magnetic field in a situation in which a magnetic field generator configured to generate a relatively large magnetic field is present nearby, a magnetometer needs to use a magnetic field vector measured from the magnetic field generator 1619 disposed at a known location and in a known direction. Here, since the location and the direction of the magnetic field generator 1619 are known in advance, the external magnetic field may be obtained by subtracting a magnetic field vector by the magnetic generator 1619 from the magnetic field vector measured by the magnetometer. Such a process of considering the external magnetic field is also referred to as calibration.

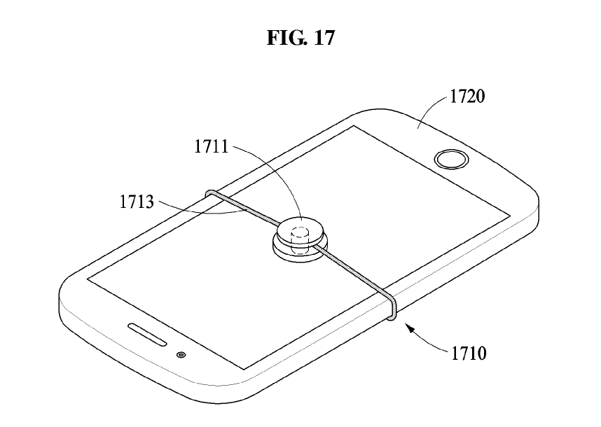

Referring to FIG. 17, an input device 1710 includes only a grip portion 1711 and an elastic member 1713. The grip portion 1711 may include a magnetic field generator therein, which is indicated by a broken line. The elastic member 1713 is provided in an annular form to cover or surround an electrical device 1720. Alternatively, as illustrated in FIGS. 14 and 16, the grip portion 1711 may be separated from the magnetic field generator in the input device 1710. For convenience of description, the grip portion 1711 includes the magnetic field generator as illustrated.

The magnetic field generator of the grip portion 1711 is disposed vertical to a front face of the electric device 1720 before the grip portion 1711 is pulled by a user, and the grip portion 1711 touches a touchscreen of the electrical device 1720. When the grip portion 1711 touches the touchscreen, a location and a direction of the magnetic field generator may be determined based on a location of the grip portion 1711 that is determined through the touchscreen and a direction in which the magnetic field generator is disposed vertical to the front face of the electrical device 1720. Here, an external magnetic field may be determined by subtracting, from a magnetic field vector detected by a magnetometer in the electrical device 1720, a magnetic field vector applied by the magnetic field generator that is calculated based on a known location and direction of the magnetic field generator.

In a case of the touchscreen of the electrical device 1720 being of a capacitive type, a point at which the grip portion 1711 touches the touchscreen may be detected by manufacturing a surface of the grip portion 1711 with a conductor, or manufacturing the surface of the grip portion 1711 with a material, for example, a material formed of rubber or silicone, that may absorb an impact caused when the grip portion 1711 is released after being pulled and then collides with the electrical device 1720. Here, the surface may be manufactured by allowing the material to have conductivity.

To remove such an impact that may be caused when the grip portion 1711 collides with the electrical device 1720, the grip portion 1711 may be disposed outside the electrical device 1720. Thus, such an impact may be generated at a location outside the electrical device 1720 even when the grip portion 1711 is released after being pulled. Here, in a case in which the grip portion 1711 is not pulled, the grip portion 1711 may be fixed to a preset location in a preset direction, and the external magnetic field may be obtained by subtracting, from a magnetic field vector measured by the magnetometer in the electrical device 1720, a magnetic field vector from the magnetic field generator.

In one example, the input device 1710 may be used as a slingshot joystick. As described above, the input device 1710 may operate in a slingshot mode, and operate in a joystick mode through a method to be described as follows.

For example, the input device 1710 moves while being in contact with the touchscreen of the electrical device 1720. In such an example, a movement of the grip portion 1711 may be determined based on a touch generated from the touchscreen when the grip portion 1711 comes into contact with the touchscreen. When the user releases the grip portion 1711 after moving the grip portion 1711 while the grip portion 1711 is being in contact with the touchscreen, the grip portion 1711 may return to a predetermined location of the electrical device 1720 by the elastic member 1713. Although, as necessary, the grip portion 1711 may not return to an accurate location before the moving, the electrical device 1720 may determine that the grip portion 1711 returns to an original location when such a returning is detected. Thus, the original location of the grip portion 1711 may change slightly.

As described, the input device 1710 includes the grip portion 1711 and the elastic member 1713. The grip portion 1711 includes the magnetic field generator, and may move while being in contact with the touchscreen of the electrical device 1720 or move to be located in the 3D space separated from the touchscreen. The elastic member 1713 is connected to the grip portion 1711 such that the grip portion 1711 has a regression characteristic to return to a predetermined location of the electrical device 1720. Here, in a case in which the touchscreen being a capacitive touchscreen, a surface of the grip portion 1711 on which the grip portion 1711 is in contact with the touchscreen may have conductivity.

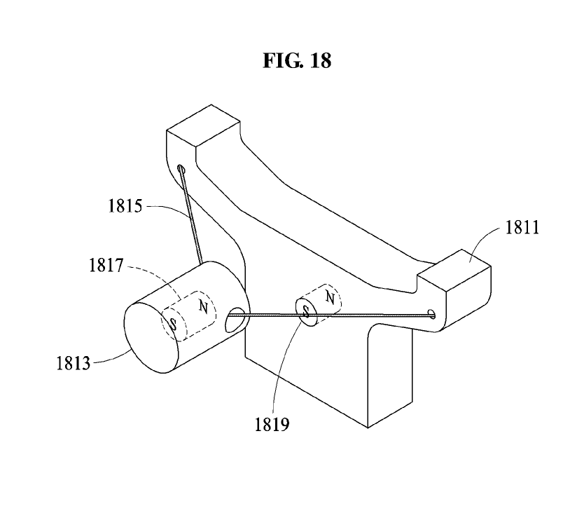

FIG. 18 is a diagram illustrating a structure to be fixed in response to a grip portion of an input device not being pulled according to another example embodiment.

In one example, to allow a magnetic field generator 1817 in a grip portion 1813 to be located at a permanently constant location despite an influence of gravity, a fixed magnet 1819 is disposed in a base portion 1811. That is, when the grip portion 1813 is not pulled, the magnetic field generator 1817 is located in a certain area due to contraction of an elastic member 1815, and the magnetic field generator 1817 is attached to the fixed magnet 1819 in the area by an attractive force with the fixed magnet 1819. Through such a structure, the grip portion 1813 may be disposed at a predetermined location in a predetermined direction even when the grip portion 1813 is not pulled.

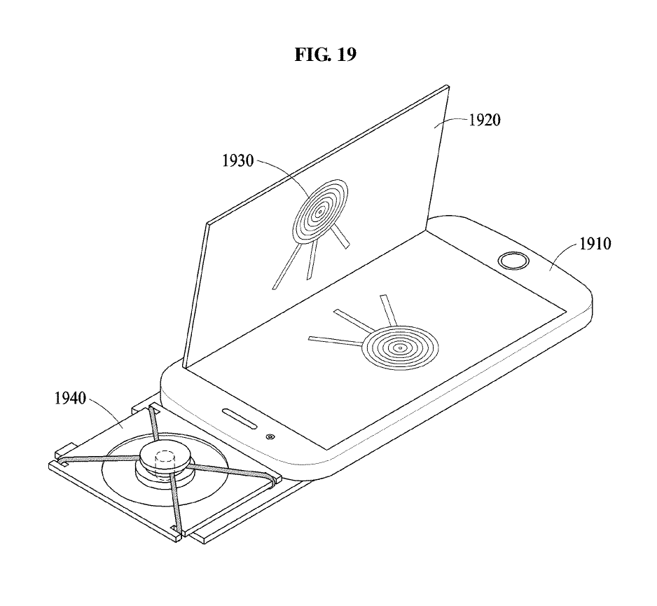

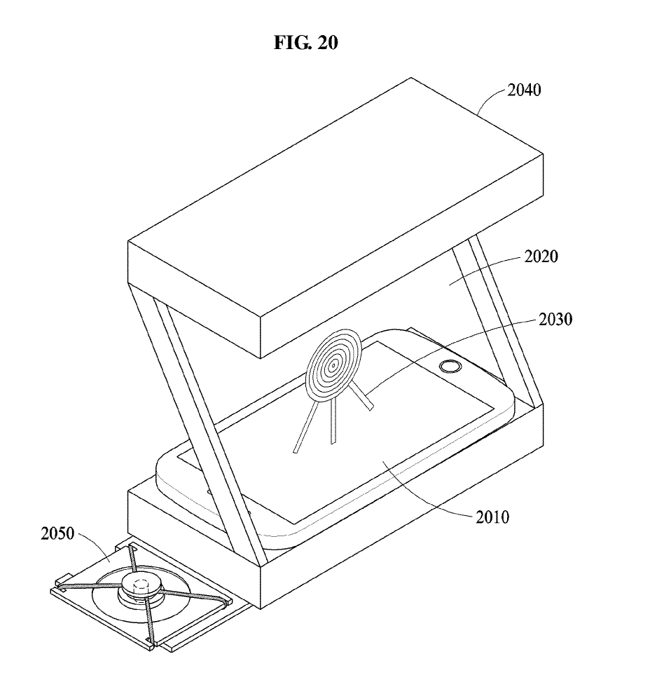

FIGS. 19 and 20 are diagrams illustrating examples in which a user views a real situation generated in front of the user according to an example embodiment.

Referring to FIG. 19, an electrical device 1910 further includes a transparent plate 1920 disposed to be inclined at a preset angle with respect to a display. The electrical device 1910 displays a virtual object 1930 that interacts with a user input received from an input device 1940. The virtual object 1930 is projected to the transparent plate 1920, and a user simultaneously views the virtual object 1930 projected to the transparent plate 1920 and a front environment crossing the transparent plate 1920. Thus, an augmented reality may be embodied simply as described.

The transparent plate 1920 is a flat plate formed of a transparent material, for example, a glass plate, an acrylic plate, and a semi-mirror. The user may adjust the virtual object 1930 displayed on the transparent plate 1920 through the input device 1940.

Referring to FIG. 20, an electrical device 2010 further includes a cover plate 2040 in an upper side of a transparent plate 2020 such that a user may view more clearly a virtual object 2030 projected to the transparent plate 2020. The cover plate 2040 may be used to allow the user to view more clearly the virtual object 2030 projected to the transparent plate 2020, which may not be clearly viewed by ambient light. The cover plate 2040 may be disposed in a right or left side of the transparent plate 2020, in addition to the upper side of the transparent plate 2020.

As described with reference to FIGS. 19 and 20, in a case in which a transparent plate, for example, the transparent plate 1920 illustrated in FIG. 19 and the transparent plate 2020 illustrated in FIG. 20, is provided, a user may not easily touch a touchscreen of an electrical device, for example, the electrical device 1910 illustrated in FIG. 19 and the electrical device 2010 illustrated in FIG. 20, which may not be viewed by the user. Here, such an inconvenience may be eased by transferring a user input to the electrical device including the transparent plate through an input device, for example, the input device 1940 illustrated in FIG. 19 and an input device 2050 illustrated in FIG. 20.

In the examples of FIGS. 19 and 20, the input device is illustrated as a slingshot joystick described with reference to FIGS. 10 through 13. However, the examples are provided for convenience of description, and thus the description provided with reference to FIGS. 19 and 20 may be applicable to an input device as a slingshot joystick described with reference to FIG. 14, a slingshot gun described with reference to FIGS. 15 through 18, an input device described with reference to FIGS. 6B and 6C, and other types of an input device described with reference to the remaining drawings.

The example embodiments according to the present disclosure are implemented in the form of a program command to be executed through diverse computer means, and recorded on a computer-readable medium. The computer-readable medium can include a program command, a data file, a data structure and so on, which may be used alone or in any combination thereof. The program command to be recorded on the medium may be specifically designed or constructed, or those well known to a person skilled in the computer software field may also be used. Examples of the computer-readable recording medium include magnetic media, such as hard disks, floppy disks and magnetic tapes; optical media, such as CD-ROMs and DVDs; magneto-optical media, such as floptical disks; and hardware devices, such as ROMs, RAMs, and flash memories, which are specifically designed to store program commands and execute them. Examples of the program command include machine codes similar to ones made by a compiler, and high-level language codes that can be executed by a computer using an interpreter for example. In order to perform the operations of the present disclosure, the aforementioned hardware device can be constructed to function as at least one software module, and vice versa.

According to the present disclosure so constructed, the following advantages can be expected. The present disclosure allows the user to be able to make his or her operation input in an intuitive and convenient manner in a variety of software, starting with computer games, 2D or 3D graphic editors, Google Earth and so on. The present disclosure makes it possible for the user to make a variety of operative instruction command, including zoom, pan, roll, pitch, yaw, selecting a value, etc., for an object in the software of a computer of a portable smart device, by using a pointing device such as a stylus pen or trackball available in any computer equipped with a magnetometer of a limited number of dimensions or a touchscreen supporting a multi-touch function. In short, the present disclosure relates to an input device and method for making an input of hand motions, drawing or clicking of the user into a computing device provided with at least one of a touchscreen, a magnetometer, and a microphone as in a smart phone or tablet. Such an input device of the present disclosure can be implemented as a low-priced accessory which includes a simple tool and a magnet, without additional sensors, circuits or communication modules, yet can sense the location as well as the angle of an object, thereby increasing the input convenience for the user.

The present disclosure has been described in detail in connection with the example embodiments and the accompanying drawings. However, the scope of the present disclosure is not limited thereto but is defined by the appended claims.

The scope of the present disclosure is not limited to the example embodiments described and illustrated above but is defined by the appended claims. It will be apparent that those skilled in the art can make various modifications and changes thereto within the scope of the disclosure defined by the claims. Therefore, the true scope of the present disclosure should be defined by the technical spirit of the appended claims.

What is claimed is:

1. An input device for transmitting a user input to an electrical device, the input device comprising:
a base portion fixed to a predetermined location of the electrical device; and
a grip portion connected to the base portion through an elastic member, and having a regression characteristic to return to a direction of the base portion in response to the grip portion being separated from the base portion by a preset distance or greater,
wherein a displacement and a rotation of the grip portion are determined based on prior physical information of the input device and a value obtained by sensing a movement of the grip portion by a sensor in the electrical device.

2. The input device of claim 1, further comprising:
a magnetic field generator connected between the base portion and the grip portion through the elastic member,
wherein the sensor in the electrical device is a magnetometer, and
the value obtained by sensing the movement of the grip portion by the sensor includes a magnetic field vector detected by the magnetometer from the magnetic field generator.

3. The input device of claim 2, wherein, in response to the grip portion being separated farther apart from the base portion based on the user input, the magnetic field generator has a shorter moving distance compared to a moving distance of the grip portion.

4. The input device of claim 1, wherein the grip portion comprises a magnetic field generator,
the sensor in the electrical device is a magnetometer, and
the value obtained by sensing the movement of the grip portion by the sensor includes a magnetic field vector detected by the magnetometer from the magnetic field generator.

5. The input device of claim 1, wherein the user input interacts with a virtual object displayed on a display in the electrical device,
wherein the virtual object is displayed on a surrounding image captured by an image sensor in the electrical device, or projected to a transparent plate inclined with respect to the display at a preset angle.

6. An input device for transmitting a user input to an electrical device, the input device comprising:
a base portion fixed to a predetermined location of the electrical device; and
a grip portion having a center-based regression characteristic to return to a predetermined location of the base portion, and configured to move while being in contact with the base portion or move to be located in a three-dimensional (3D) space separated from the base portion,
wherein a displacement or a rotation of the grip portion is determined based on prior physical information of the input device and a value obtained through sensing associated with the grip portion by a sensor in the electrical device.

7. The input device of claim 6, wherein the prior physical information of the input device includes information associated with the location of the electrical device to which the base portion is fixed.

8. The input device of claim 6, wherein the prior physical information of the input device includes restriction information associated with a restriction on a movement of the grip portion.

9. The input device of claim 8, wherein the restriction information associated with the restriction on the movement of the grip portion includes information associated with a movable range in which the grip portion moves while being in contact with the base portion by the user input and information associated with an available location range in which the grip portion is separated from the base portion and located in the 3D space.

10. The input device of claim 8, wherein the restriction information associated with the restriction on the movement of the grip portion includes information associated with an original location of the grip portion at which the grip portion is located in the absence of a user input about the grip portion.

11. The input device of claim 6, wherein a user input allowing the grip portion to move while being in contact with the base portion is recognized based on a distance between the base portion and the grip portion.

12. The input device of claim 11, wherein the user input allowing the grip portion to move while being in contact with the base portion is recognized further based on at least one of a difference between an arrangement direction of the base portion and an arrangement direction of the grip portion or a distance, to the grip portion, from an original location of the grip portion at which the grip portion is located in the absence of the user input about the grip portion.

13. The input device of claim 6, wherein a user input allowing the grip portion located in the 3D space separated from the base portion to return to an original location based on the center-based regression characteristic is recognized based on a change in a magnetic field generated based on a movement of the grip portion returning to the original location, in response to the grip portion including a magnetic field generator and the sensor in the electrical device being a magnetometer.

14. The input device of claim 6, wherein a direction in which the grip portion located in the 3D space separated from the base portion returns to an original location is determined based on a previous location at which the grip portion is located immediately before returning to the original location and the original location of the grip portion.

15. The input device of claim 6, wherein, in response to the grip portion including a magnetic field generator and the sensor in the electrical device being a magnetometer, the displacement or the rotation of the grip portion is determined based on an original location of the grip portion in the absence of a user input about the grip portion and an external magnetic field determined based on a magnetic field vector detected by the sensor in response to the grip portion being located at the original location.

16. The input device of claim 6, wherein the center-based regression characteristic of the grip portion is based on an elastic member connecting the grip portion and the base portion or an electromagnetic attractive force between the grip portion and the base portion.

17. The input device of claim 6, wherein, in response to the sensor in the electrical device being a magnetometer, an m dimension of a magnetic field vector detected by the magnetometer is less than n degrees of freedom (DOF) of the grip portion.

18. The input device of claim 6, wherein a user input allowing the grip portion to move while the grip portion is being in contact with the base portion and a user input allowing the grip portion to be located in the 3D space separated from the base portion induce different types of operations in the electrical device.

19. The input device of claim 18, wherein a user input allowing the grip portion located in the 3D space separated from the base portion to return to an original location based on the center-based regression characteristic induces a subsequent operation of the electrical device after an operation of the electrical device performed by a user input allowing the grip portion to be located in the 3D space.

20. An input device for transmitting a user input to an electrical device, the input device comprising:
a base portion; and
a grip portion having a center-based regression characteristic to return to a predetermined location of the base portion, and configured to move while being in contact with the base portion or move to be located in a three-dimensional (3D) space separated from the base portion.

21. The input device of claim 20, further comprising:
a control portion configured to determine a displacement or a rotation of the grip portion based on prior physical information of the input device and a value obtained by sensing a relative movement between the base portion and the grip portion by a sensor.

22. The input device of claim 20, further comprising:
a communication portion configured to transmit, to the electrical device, the value obtained by sensing the relative movement between the base portion and the grip portion by the sensor, or information derived from the relative movement,
wherein the electrical device is configured to determine a displacement or a rotation of the grip portion based on the prior physical information of the input device and the value obtained by the sensor.

23. An input device for transmitting a user input to an electrical device, the input device comprising:
a grip portion including a magnetic field generator, and configured to move while being in contact with a touchscreen of the electrical device or move to be located in a three-dimensional (3D) space separated from the touchscreen; and
an elastic member connected to the grip portion and configured to allow the grip portion to return to a predetermined location of the electrical device,
wherein a displacement or a rotation of the grip portion is determined based on prior physical information of the input device, a magnetic field vector generated by a magnetometer in the electrical device from the magnetic field generator, and a touch generated from the touchscreen in response to the grip portion being in contact with the touchscreen.

24. The input device of claim 23, wherein, in response to the touchscreen being a capacitive touchscreen, a surface of the grip portion touching the touchscreen is conductive.
